(19) United States
(12) Patent Application Publication
(10) Pub. No.: US 2026/0127771 A1
(43) Pub. Date: May 7, 2026

(54) SPECTRAL COMPRESSION FOR DYNAMIC MESH ENCODING

(71) Applicant: InterDigital CE Patent Holdings, SAS, Paris (FR)

(72) Inventors: Jean-Eudes MARVIE, PLERIN (FR); Olivier MOCQUARD, Cesson-Sevigne (FR); Maja KRIVOKUCA, Cesson-Sevigne (FR); Julien RICARD, Plouër-sur-Rance (FR)

(21) Appl. No.: 19/117,500

(22) PCT Filed: Oct. 4, 2023
(86) PCT No.: PCT/EP2023/077379

§ 371 Date: Apr. 1, 2025

(30) Foreign Application Priority Data
Oct. 19, 2022 (EP) 22306582.2

(51) Int. Cl. G06T 9/00

(52) U.S. Cl. CPC G06T 9/001

(57) ABSTRACT

Apparatuses and methods are disclosed for encoding and decoding mesh data. Encoding techniques are disclosed including coding a mesh into a bitstream. The coding includes generating a base mesh from the mesh, obtaining connectivity and geometry data of the base mesh. Then, subdividing the base mesh, obtaining connectivity and geometry data of the subdivided mesh. Coding proceeds by generating GFT coefficients, based on a Graph Fourier Transform (GFT), using displacement data, and then, coding into the bitstream the coefficients and connectivity data of the base mesh. Decoding techniques are disclosed including decoding the mesh from the bitstream. The decoding includes decoding from the bitstream connectivity data of the base mesh and subdividing the base mesh, obtaining connectivity data of the subdivided mesh. Decoding proceeds by decoding from the bitstream the GFT coefficients and reconstructing the mesh based on the decoded connectivity data of the subdivided mesh and the decoded coefficients.

### CROSS REFERENCE TO RELATED APPLICATIONS

This application claims the benefit of European Application No. 22306582.2, filed on Oct. 19, 2022, which is incorporated herein by reference in its entirety.

### BACKGROUND

A significant amount of data is required for high quality representation and rendering of content modeled by dynamic meshes. Compression techniques are instrumental in distributing such content to consumers. Generally, the computational complexity of encoding and decoding the geometry and topology of dynamic meshes is proportional to the size of these meshes and compression efficiency depends on how well a coding technique reduces spatiotemporal redundancy. The former can be addressed by techniques that are scalable, whereas the latter can be addressed by techniques that take advantage of spatiotemporal correlations that are typically present in dynamic mesh data.

### SUMMARY

Apparatuses and methods are disclosed herein for encoding and decoding time-varying textured meshes. Recently, the MPEG 3D Graphics Coding (MPEG-3DGC) group called for proposals (CfP) for codec technologies relating to the compression of time-varying volumetric meshes (V-Mesh). See, CfP for Dynamic Mesh Coding, ISO/IEC JTC 1/SC 29/WG 7, 2021. In response, the solution proposed by Mammou et al. was selected to become the MPEG V-Mesh Test Model that will be used as a basis for future development of this standard. See, K. Mammou, J. Kim, A. Tourapis, D. Podborski and K. Kolarov, “MPEG input document m59281-v4-[V-CG] Apple's Dynamic Mesh Coding CfP Response,” ISO/IEC JTC 1/SC 29/WG 7, 2022 (“Mammou”). Aspects disclosed herein refine the MPEG V-Mesh Test Model (referred to herein as “the test model”) to extend its compression capabilities.

Aspects disclosed in the present disclosure describe methods for encoding mesh data. The methods comprise receiving a mesh sequence and coding a mesh of the sequence into a bitstream. The coding of a mesh includes generating a base mesh from the mesh, obtaining connectivity data and geometry data associated with vertices of the base mesh. Then, subdividing the base mesh, obtaining connectivity data and geometry data associated with vertices of the subdivided mesh. The coding proceeds by computing displacement data, representing spatial differences between vertices of the subdivided mesh and corresponding vertices of the mesh; generating GFT coefficients, based on a Graph Fourier Transform (GFT), using the computed displacement data; and coding into the bitstream the GFT coefficients and connectivity data of the base mesh.

Aspects disclosed in the present disclosure also describe methods for decoding mesh data. The methods comprise receiving a bitstream of a coded mesh sequence and decoding a mesh from the sequence. The decoding of a mesh includes decoding from the bitstream connectivity data associated with vertices of a base mesh. Then, subdividing the base mesh, obtaining connectivity data associated with vertices of a subdivided mesh. The decoding proceeds by decoding from the bitstream GFT coefficients, generated by an encoder based on a GFT using displacement data representing spatial differences between vertices of the subdivided mesh and corresponding vertices of the mesh; and reconstructing the mesh based on the connectivity data of the subdivided mesh and the decoded GFT coefficients.

Aspects disclosed in the present disclosure describe an apparatus for encoding mesh data. The apparatus comprises at least one processor and memory storing instructions. The instructions, when executed by the at least one processor, cause the apparatus to receive a mesh sequence and to code a mesh of the sequence into a bitstream. The coding of a mesh includes generating a base mesh from the mesh, obtaining connectivity data and geometry data associated with vertices of the base mesh. Then, subdividing the base mesh, obtaining connectivity data and geometry data associated with vertices of the subdivided mesh. The coding proceeds by computing displacement data, representing spatial differences between vertices of the subdivided mesh and corresponding vertices of the mesh; generating GFT coefficients, based on a Graph Fourier Transform (GFT), using the computed displacement data; and coding into the bitstream the GFT coefficients and connectivity data of the base mesh.

Aspects disclosed in the present disclosure also describe an apparatus for decoding mesh data. The apparatus comprises at least one processor and memory storing instructions. The instructions, when executed by the at least one processor, cause the apparatus to receive a bitstream of a coded mesh sequence and to decode a mesh from the sequence. The decoding of a mesh includes decoding from the bitstream connectivity data associated with vertices of a base mesh. Then, subdividing the base mesh, obtaining connectivity data associated with vertices of a subdivided mesh. The decoding proceeds by decoding from the bitstream GFT coefficients, generated by an encoder based on a GFT using displacement data representing spatial differences between vertices of the subdivided mesh and corresponding vertices of the mesh; and reconstructing the mesh based on the connectivity data of the subdivided mesh and the decoded GFT coefficients.

Aspects disclosed in the present disclosure describe a non-transitory computer-readable medium comprising instructions executable by at least one processor to perform methods for encoding mesh data. The methods comprise. The methods comprise receiving a mesh sequence and coding a mesh of the sequence into a bitstream. The coding of a mesh includes generating a base mesh from the mesh, obtaining connectivity data and geometry data associated with vertices of the base mesh. Then, subdividing the base mesh, obtaining connectivity data and geometry data associated with vertices of the subdivided mesh. The coding proceeds by computing displacement data, representing spatial differences between vertices of the subdivided mesh and corresponding vertices of the mesh; generating GFT coefficients, based on a Graph Fourier Transform (GFT), using the computed displacement data; and coding into the bitstream the GFT coefficients and connectivity data of the base mesh.

Aspects disclosed in the present disclosure also describe a non-transitory computer-readable medium comprising instructions executable by at least one processor to perform methods for decoding mesh data. The methods comprise receiving a bitstream of a coded mesh sequence and decoding a mesh from the sequence. The decoding of a mesh includes decoding from the bitstream connectivity data associated with vertices of a base mesh. Then, subdividing the base mesh, obtaining connectivity data associated with vertices of a subdivided mesh. The decoding proceeds by decoding from the bitstream GFT coefficients, generated by an encoder based on a GFT using displacement data representing spatial differences between vertices of the subdivided mesh and corresponding vertices of the mesh; and reconstructing the mesh based on the connectivity data of the subdivided mesh and the decoded GFT coefficients.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 illustrates surface refinement using an iterative subdivision process, according to aspects of the present disclosure.

FIG. 2 is a functional block diagram of an example system for dynamic mesh encoding, according to aspects of the present disclosure.

FIG. 3 is a functional block diagram of an example system for dynamic mesh decoding, according to aspects of the present disclosure.

FIG. 4 is a functional block diagram of an example base mesh encoder, according to aspects of the present disclosure.

FIG. 5 is a functional block diagram of an example base mesh decoder, according to aspects of the present disclosure.

FIG. 6 is a functional block diagram of an example wavelet-based encoder, according to aspects of the present disclosure.

FIG. 7 is a functional block diagram of an example wavelet-based decoder, according to aspects of the present disclosure.

FIG. 8 is a functional block diagram of an example mesh reconstructor, according to aspects of the present disclosure.

FIG. 9 is a functional block diagram of an example spectral-based encoder, according to aspects of the present disclosure.

FIG. 10 is a functional block diagram of an example spectral-based decoder, according to aspects of the present disclosure.

FIG. 11 is a functional block diagram of an example mesh reconstructor, according to aspects of the present disclosure.

FIG. 12 illustrates an example of spectral-based encoding in a first operational mode, according to aspects of the present disclosure.

FIG. 13 illustrates an example of spectral-based decoding in the first operational mode, according to aspects of the present disclosure.

FIG. 14 is a functional block diagram of an example spectral-based encoder, according to aspects of the present disclosure.

FIG. 15 is a functional block diagram of an example spectral-based decoder, according to aspects of the present disclosure.

FIG. 16 is a functional block diagram of an example mesh reconstructor, according to aspects of the present disclosure.

FIG. 17 illustrates an example of spectral-based encoding in a third operational mode, according to aspects of the present disclosure.

FIG. 18 illustrates an example of spectral-based decoding in the third operational mode, according to aspects of the present disclosure.

FIG. 19 illustrates an example for stitching mesh patches, according to aspects of the present disclosure.

FIG. 20 illustrates an example for stitching mesh patches, according to aspects of the present disclosure.

FIG. 21 is a flow diagram of an example method for encoding mesh data, according to aspects of the present disclosure.

FIG. 22 is a flow diagram of an example method for decoding mesh data, according to aspects of the present disclosure.

### DETAILED DESCRIPTION

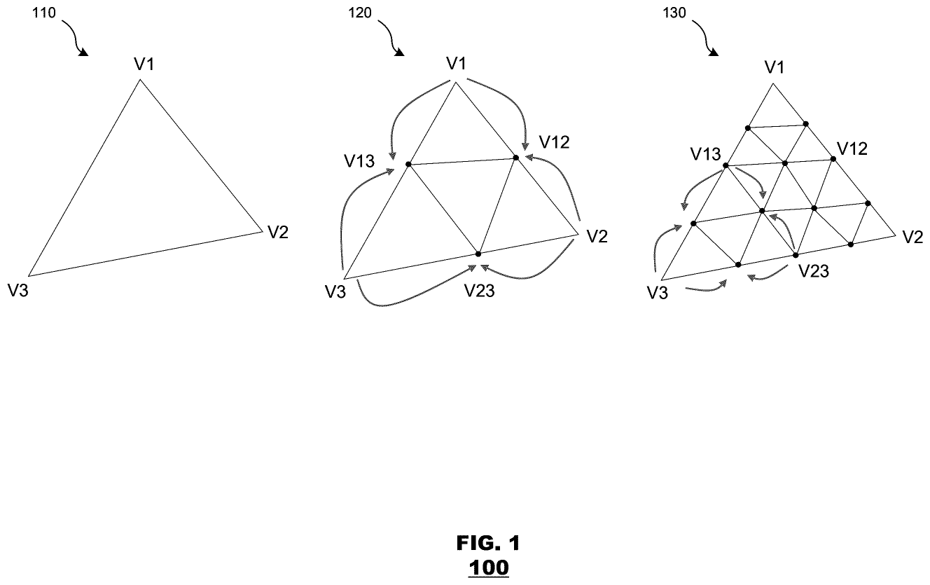

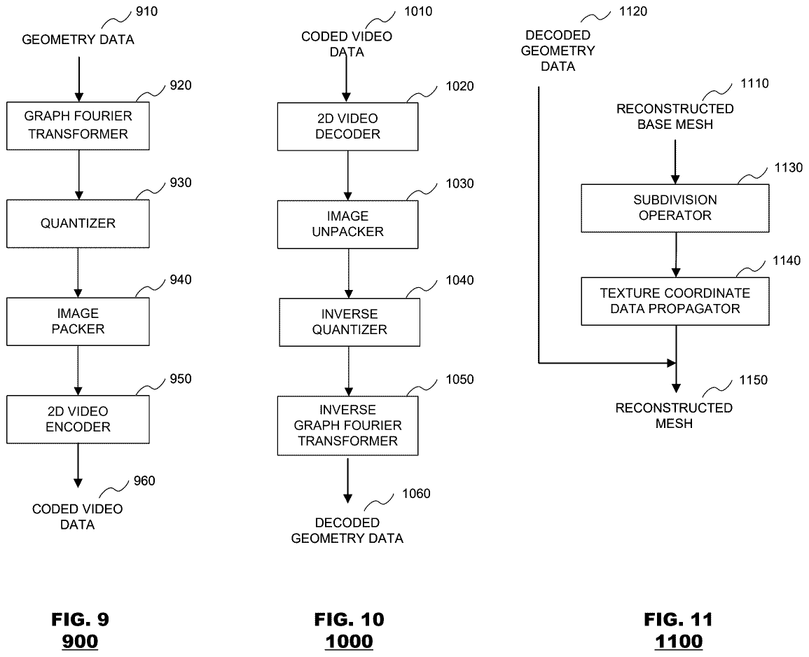

Aspects of the present disclosure extends the test model, described in Mammou, proposing variations in which spectral coding is applied to the coding of a dynamic mesh. Further aspects can reduce the computational complexity of encoding a large mesh by independently applying spectral coding to patches of that mesh and stitching the reconstructed patches to eliminate gaps in the surface representation of the reconstructed mesh. The dynamic mesh codec, employed by the test model, is generally described herein in reference to FIGS. 1-8, followed by a description of aspects of the present disclosure in reference to FIG. 9-22.

The test model first decomposes a given mesh to be encoded into a base mesh and displacement vectors that represent the spatial difference between the given mesh and the base mesh. Then, the test model encodes separately the base mesh and the displacement vectors. The encoding of the base mesh can be performed independently (by any static mesh coding technique) or in reference to a previously encoded base mesh (that is, a reference base mesh). In the latter, a motion field that represents the spatial relation between corresponding vertices of the base mesh and of the reference base mesh is encoded. The encoding of the displacement vectors relies on wavelet-based coding. To that end, the base mesh is first refined (applying tessellation or subdivision operation) by introducing new vertices. The newly generated vertices are then displaced, according to displacement vectors, to reach the surface of the mesh to be encoded. In the test model, those displacement vectors are represented by wavelet coefficients, packed into two-dimensional images, and then encoded by a conventional video encoder. Using the test model, 6% of the model data represent the base mesh geometry and connectivity, and 94% of the model data represent the wavelet coefficients. The advantage of this approach is two-fold. First, a large part of the connectivity data need not be encoded due to the use of a small base mesh (instead of the original mesh to be encoded) and the use of a regular subdivision. Second, the wavelet coefficients used to represent the displacement vectors are quite compact and suitable for arithmetic encoding or video encoding.

Hence, the coding of the mesh geometry is based on a surface subdivision scheme which begins with the base mesh. The base mesh contains a relatively small number of vertices and faces, which are then iteratively refined in a predictable manner. To that end, a subdivision process is applied that adds new vertices and faces to the base mesh by iteratively subdividing the existing faces into smaller sub-faces. The new vertices are then displaced to new positions according to pre-defined rules, to gradually refine the mesh shape and bring it closer to the original mesh to be encoded. Different surface subdivision schemes can be applied to the base mesh. See, for example, A. Benton, “Advanced Graphics—Subdivision Surfaces,” University of Cambridge. In Mammou, a simple mid-point subdivision scheme is used, as further described below. Since the connectivity of the base mesh can be refined in a predictable manner by using a set of subdivision rules known to both the encoder and the decoder, the only connectivity information that needs to be encoded and provided to the decoder is the connectivity of the base mesh. In addition to base mesh connectivity, base mesh geometry as well as displacement vectors have to be encoded and provided to the decoder, as further described below.

Generally, a mesh is a representation of a surface, including vertices that are associated with three dimensional (3D) locations on the surface; the vertices are connected by edges, forming planar faces (such as triangles) that approximate the surface. Other information may be associated with each of the mesh's vertices, namely, vertex attributes (e.g., mapping parameters, normal vectors, or color values). In addition, the surface can be further represented by various attribute maps (2D images). To associate faces (e.g., triangles) of the mesh with corresponding attribute data, the faces are mapped onto an attribute map based on mapping parameters associated with respective vertices. Attribute maps may include texture data or other data that are characteristic of other physical properties of the surface (e.g., surface reflectance and transparency) that may be required for realistic rendering of the surface. Hence, mesh representation of a surface typically consists of mesh data, denoted M, and attribute map(s), denoted A. The former can include connectivity (topology) data, geometry data, and other attribute data associated with the mesh vertices. Aspects described herein with respect to textural data (represented by textural maps and respective texture mapping parameters) are applicable to other types of data (generally represented by attribute maps and respective mapping parameters).

FIG. 1 illustrates surface refinement using an iterative subdivision process. Therein, a mid-point subdivision scheme is demonstrated, where a face (triangle) of a base mesh 110 is subdivided into 4 faces 120 and then subdivided again into 16 faces 130. Thus, at each iteration, this subdivision process, starting from a base mesh 110, splits three edges of each triangle in the center, forming four new triangles. The vertex position coordinates, Pᵥ_{ᵢ}=(xᵥ_{ᵢ}, yᵥ_{ᵢ}, zᵥ_{ᵢ}), as well as the texture mapping coordinates Tᵢ=(uᵢ, vᵢ) associated with a newly added vertex, vᵢ, can be derived from the position coordinates and texture coordinates of respective parents in the subdivided mesh. For example, Pᵥ_{₁₂} and Tᵥ_{₁₂} can be linearly interpolated as follows:

$${P}_{{v}_{12}} = \frac{{P}_{{v}_{1}} + {P}_{{v}_{2}}}{2} \qquad ( 1 )$$

$${T}_{{v}_{12}} = \frac{{T}_{{v}_{1}} + {T}_{{v}_{2}}}{2} \qquad ( 2 )$$

It can be seen that the subdivision process can be done based on the mesh connectivity data alone, without reliance on other data associated with the vertices themselves (e.g., position coordinates). However, if data associated with vertices of the base mesh are available, data associated with the remaining vertices of the subdivided mesh can be derived therefrom.

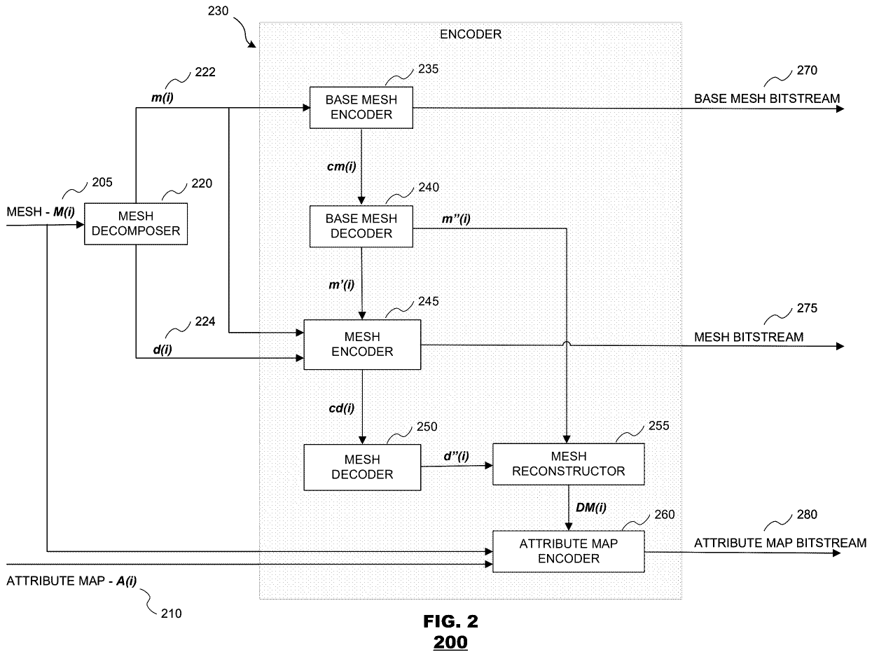

FIG. 2 is a functional block diagram of an example system 200 for dynamic mesh encoding. The system 200 illustrates the encoding of a frame sequence F(i), where data associated with frame i include a mesh M(i) 205 and corresponding attribute map(s) A(i) 210. The system 200 includes a mesh decomposer 220 and an encoder 230. The mesh decomposer 220 is configured to decompose a received mesh M(i) 205 into a base mesh m(i) 222 and corresponding displacement vectors d(i) 224. The generated base mesh m(i) 222 and displacement vectors d(i) 224, together with the corresponding attribute map(s) A(i) 210, are then fed into the encoder 230. The encoder 230 encodes the obtained data—m(i), d(i), and A(i)—generating therefrom respective bitstreams, including a base mesh bitstream 270, a mesh bitstream 275, and an attribute map bitstream 280. The operation of the mesh decomposer 220 and the operation of the encoder 230 are further described below.

The decomposer 220 is configured to decompose a mesh M(i) 205 into a base mesh m(i) 222 and corresponding displacement vectors d(i) 224. To generate a base mesh m(i), the decomposer 220 decimates the mesh M(i) by sub-sampling the mesh's vertices, forming a mesh with fewer and larger faces (e.g., as the face 110 of a base mesh, demonstrated in FIG. 1). A mesh subdivision is then generated by subdividing the base mesh m(i), that is, each face of the base mesh is subdivided into multiple sub-faces, introducing additional new vertices. Any subdivision scheme may be applied, optionally iteratively, as demonstrated in FIG. 1, to generate a subdivided base mesh. Next, the decomposer 220 determines displacement vectors d(i) 224 for respective vertices of the subdivided base mesh, so that when applied to those vertices, a deformed mesh is generated that spatially fits the given mesh M(i) 205 to be encoded. Decomposing the given mesh M(i) in this manner—to allow separate encoding of the base mesh m(i) and its corresponding displacement vectors d(i) instead of directly encoding the mesh M(i)—improves compression efficiency. This is because the base mesh m(i) has fewer vertices relative to the mesh M(i), and, therefore, can be encoded by a relatively smaller number of bits. Furthermore, the displacement vectors d(i) can be efficiently encoded using, for example, a wavelet transform, enabled by the subdivision structure. In turn, the used subdivision structure need not be explicitly encoded as it can be determined by the decoder. For example, the decoder can subdivide the decoded base mesh based on a subdivision scheme type and a subdivision iteration count (subdivision depth) that can be signaled in the bitstream.

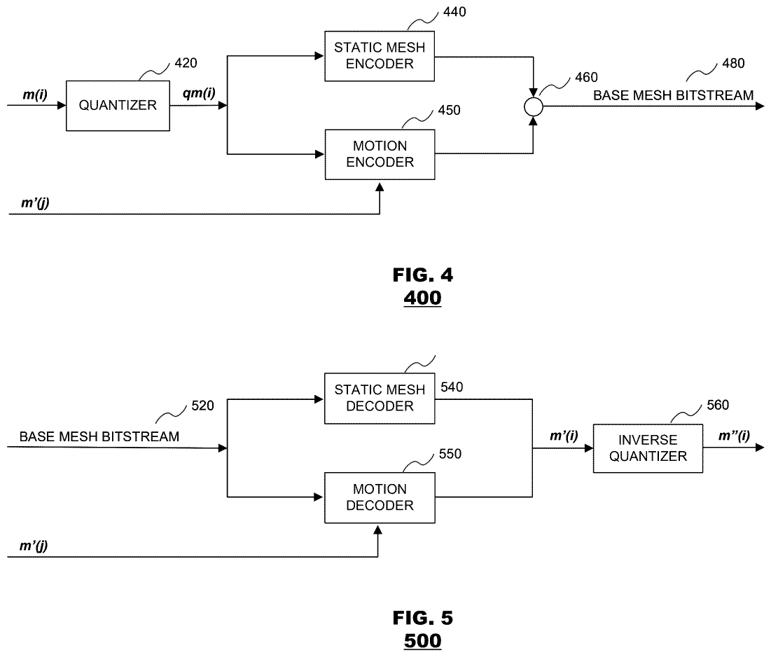

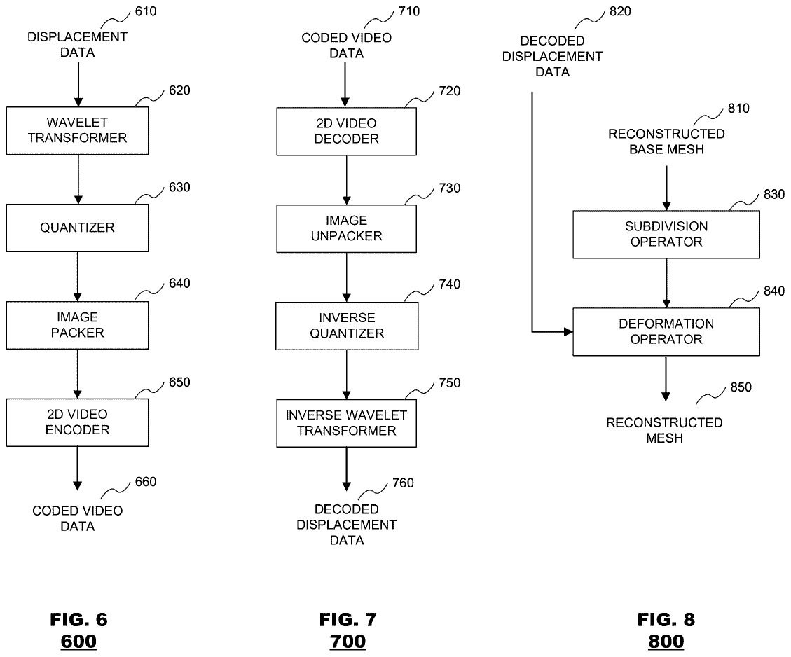

As illustrated in FIG. 2, the encoder 230) includes a base mesh encoder 235, a base mesh decoder 240), a mesh encoder 245, a mesh decoder 250), a mesh reconstructor 255, and an attribute map encoder 260. The base mesh encoder 235 is configured to encode the base mesh m(i) into coded base mesh cm(i) and to generate therefrom the base mesh bitstream 270. The base mesh decoder 240 is configured to reconstruct (decode) the base mesh from the coded base mesh cm(i), resulting in a reconstructed quantized base mesh m′(i) and a reconstructed base mesh m″(i). The base mesh encoder 235 and decoder 240 are further described in reference to FIG. 4 and FIG. 5, respectively. The mesh encoder 245 receives as input the base mesh m(i) and the reconstructed quantized base mesh m′(i), based on which it is configured to update and to encode the received displacement vectors d(i) into coded displacement vectors cd(i) and to generate therefrom the mesh bitstream 275. The mesh decoder 250 is configured to reconstruct (decode) the displacement vectors from the coded displacement vectors cd(i), resulting in reconstructed displacement vectors d″(i). The mesh encoder 245 and the mesh decoder 250 are further described in reference to FIG. 6 and FIG. 7, respectively. Following the mesh displacement encoding 245 and the decoding 250) operations, the mesh reconstructor 255 is configured to generate the reconstructed mesh DM(i) based on the reconstructed base mesh m″(i) and the reconstructed displacement vectors d″(i), as further described in reference to FIG. 8. Based on the mesh M(i) and the reconstructed mesh DM(i), the attribute map encoder 260 is configured to encode the attribute map(s) A(i) 210 into coded attribute map(s) and to generate therefrom the attribute map bitstream 280.

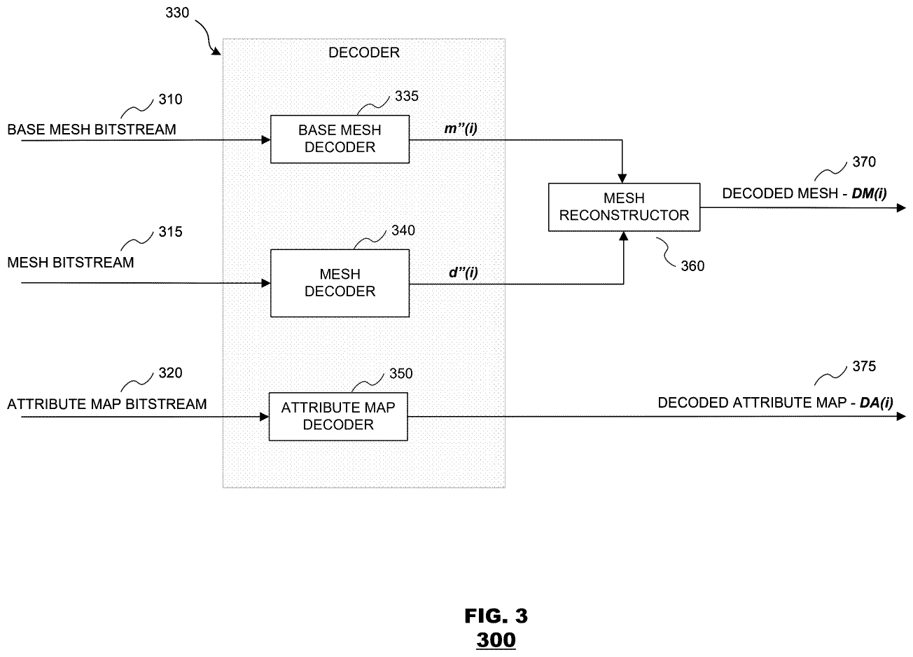

FIG. 3 is a functional block diagram of an example system 300 for dynamic mesh decoding. The system 300 is configured to generally reverse the operation of system 200, including a decoder 330 and a mesh reconstructor 360. The decoder 330 includes a base mesh decoder 335, a mesh decoder 340), and an attribute map decoder 350. The base mesh decoder 335 decodes the reconstructed base mesh m″(i) out of the base mesh bitstream 310, 270, as further described in reference to FIG. 5. The mesh decoder 340 decodes the reconstructed displacement vectors d″(i) out of the mesh bitstream 315, 275, as described in reference to FIG. 7. The attribute map decoder 350 decodes the attribute map out of the attribute map bitstream 320, 280, reversing the operation of the attribute map encoder 260 to generate the reconstructed attribute map DA(i) 375. The decoder's 330 outputs—the reconstructed base mesh m″(i) and the reconstructed displacement vectors d″(i)—are used by the mesh reconstructor 360 to reconstruct the decoded mesh DM(i) 370, as described in reference to FIG. 8.

FIG. 4 is a functional block diagram of an example base mesh encoder 400. The base mesh encoder 400 includes a quantizer 420, a static mesh encoder 440, a motion encoder 450, and a selector 460. As described above in reference to the base mesh encoder 235 of FIG. 2, the base mesh encoder 400 is configured to encode a base mesh m(i) into the base mesh bitstream 480. To that end, two encoders 440, 450 may be employed. Thus, following quantization 420, the static mesh encoder 440 encodes the quantized base mesh qm(i) according to any static mesh encoding method. For example, Edgebreaker is used in the test model to encode the base mesh. See, J. Rossignac, “3D compression made simple: Edgebreaker with ZipandWrap on a corner-table,” in Proceedings International Conference on Shape Modeling and Applications, Genova, Italy, 2000. Additionally, following quantization 420, the motion encoder 450 encodes the quantized base mesh qm(i) relative to a reference base mesh, that is, a reconstructed quantized base mesh, denoted m′(j). For example, the reference base mesh, m′(j), may be associated with a previous reconstructed quantized base mesh m′(i−1). Thus, the motion encoder 450 encodes a motion field f(i) that describes the motion that vertices of m′(j) have to undergo in order to reach respective locations of corresponding vertices of qm(i) (or vice versa), as further described below.

Hence, when employing the motion encoder 450, it is assumed that the base mesh and the reference base mesh share the same number of vertices and the same vertex connectivity—that is, only the locations of corresponding vertices change over time. To maintain the same number of vertices and the same vertex connectivity in base meshes of the frame sequence, the encoder 400, for example, can keep track of the transformation applied to the geometry of a previous base mesh and apply the same to a current base mesh. Under such conditions, the motion encoder 450 can be configured to first compute a motion field f(i), and, then, to encode the computed motion field into the base mesh bitstream 480. The motion field f(i) contains motion vectors respective of corresponding vertices in the quantized base mesh qm(i) and the reference reconstructed quantized m′(j), as follows:

$$f ( i ) = {P}_{qm ( i )} - {P}_{{m}^{′} ( j )} , \qquad ( 3 )$$

where P_{qm(i)} is a vector containing geometry data (vertex positions) of the quantized base mesh qm(i) and where P_{m′(j)} is a vector containing geometry data (corresponding vertex positions) of a reference reconstructed quantized base mesh m′(j). In an aspect, the motion encoder 450 may further adjust the motion vectors (e.g., based on neighboring motion vectors) and then encode the adjusted motion vectors using an entropy coder, for example.

The choice whether to use the output of the static mesh encoder 440 or the output of the motion encoder 450 can be carried out by the selector 460. In Mammou, it is proposed to select the bitstream of the encoder (440 or 450) that results in the least geometric distortion. A preferred approach is to consider the overall rate-distortion cost introduced by the dynamic mesh encoding (via encoder 230) when selecting between the output of the static mesh encoder 440 and the output of the motion encoder 450. Accordingly, rate-distortion optimization that accounts for topological and photometric distortions as well as bitrate levels can be performed. Such rate-distortion optimization can lead to a selection of the encoder (440 or 450) that will provide more efficient coding, corresponding to optimal rate-distortion cost, as disclosed in application no. EP22306231.6, titled Rate Distortion Optimization for Time Varying Textured Mesh Compression, the disclosure of which is incorporated by reference herein in its entirety.

FIG. 5 is a functional block diagram of an example base mesh decoder 500. The base mesh decoder 500 generally reverses the operation of the base mesh encoder 400. It 500 includes a static mesh decoder 540, a motion decoder 550 and an inverse quantizer 560. As described above in reference to the base mesh decoder 335 of FIG. 3, the base mesh decoder 500 is configured to decode the reconstructed base mesh m″(i) out of the base mesh bitstream 520, 480. To that end, the base mesh decoder 500 directs an incoming base mesh stream 520 (representing a coded base mesh cm(i)) either to the static mesh decoder 540 or to the motion decoder 550. Such direction can be made based on signaling in the bitstream 520 indicative of whether the coded base mesh cm(i) was encoded by the static mesh encoder 440 or the motion encoder 450. If the bitstream 520 is directed to the static mesh decoder 540, this decoder decodes the base mesh from the bitstream 520, resulting in the reconstructed quantized base mesh m′(i). Otherwise, if the bitstream 520 is directed to the motion decoder 550, this decoder decodes the motion field from the bitstream 520 and adds the reconstructed (decoded) motion field to the reference reconstructed quantized base mesh m′(j), resulting in the reconstructed quantized base mesh m′(i). The resulting m′(i) is then provided to the inverse quantizer 560 that generates therefrom the reconstructed base mesh m″(i). As described above, the base mesh decoder 500 is also employed in the encoder 230, where it 240 provides the reconstructed quantized base mesh m′(i) and the reconstructed base mesh m″(i) to the mesh encoder 245 and the mesh reconstructor 255, respectively.

FIG. 6 is a functional block diagram of an example wavelet-based encoder 600 (e.g., employable by the mesh encoder 245 of FIG. 2). The mesh encoder 600 encodes displacement data 610 representative of the spatial difference between the surfaces represented by the base mesh m(i) and the original mesh M(i) of a frame i. Thus, the mesh encoder 245 encodes the displacement vectors d(i) that, as mentioned above, are associated with respective vertices of the subdivided base mesh. To that end, the displacement vectors are first updated based on the reconstructed quantized base mesh m′(i) (not shown). Then, a wavelet transform is applied to represent the updated displacement vectors d′(i)—that is, wavelet coefficients are extracted, by a wavelet transformer 620, in conjunction with the subdivision process with which the base mesh is subdivided. These wavelet coefficients are then quantized, by a quantizer 630. The quantizer 630 may be a uniform scalar quantizer with a dead-zone (that is, a symmetric area around zero, typically, with a larger width than the other quantization steps, so that more of the small input values will be quantized to zero). Next, the quantized wavelet coefficients are packed, by an image packer 640, into a 2D image. The 2D image is then encoded by a 2D video encoder 650, generating coded video data 660. Note that the 2D video encoder 650 may implement any video encoding method (either lossless or lossy) in accordance with a specific application's requirements.

FIG. 7 is a functional block diagram of an example wavelet-based decoder 700 (e.g., employable by the mesh decoder 250, 340 shown in FIG. 2 and FIG. 3). The mesh decoder 700 generally reverses the operation of the mesh encoder 600. Accordingly, the mesh decoder 700 employs a 2D video decoder 720 to decode a packed 2D image from the coded video data 710 (generated by the 2D video encoder 650). Next, an image unpacker 730 is employed to unpack the decoded 2D image to obtain the quantized wavelet coefficients (generated by the quantizer 630). An inverse quantizer 740 dequantizes the quantized wavelet coefficients (generated by the wavelet transformer 620). The dequantized wavelet coefficients are then inverse transformed, by an inverse wavelet transformer 750, generating decoded displacement data 760—that is, the reconstructed displacement vectors d″(i).

FIG. 8 is a functional block diagram of an example mesh reconstructor 800 (e.g., employable by the mesh reconstructor 255, 360 shown in FIG. 2 and FIG. 3). The mesh reconstructor 800 is configured to generate the reconstructed mesh DM(i) 850 based on the reconstructed base mesh m″(i) 810 and the decoded displacement data 820—that is, the reconstructed displacement vectors d′(i). To that end, the reconstructed base mesh m″(i) is subdivided according to the used subdivision scheme, by a subdivision operator 830, generating a subdivided base mesh whose vertex positions are interpolated based on the vertices of the reconstructed base mesh. The reconstructed displacement vectors d′(i) 820 are then applied to the reconstructed subdivided base mesh, by a deformation operator 840, in effect deforming the reconstructed subdivided base mesh to obtain the reconstructed mesh DM(i) 850.

Note that a video encoder is applied to the task of compressing the packed wavelet coefficients (by the mesh encoder 245) and to the task of compressing the attribute map(s) (by the attribute map encoder 260). Any video encoding method (either lossless or lossy) may be employed for these tasks, in accordance with a specific application's requirements.

Aspects of the present disclosure describe alternative techniques to encode geometry data and displacement data utilizing a Graph Fourier Transform (GFT). See, A. Ortega, P. Frossard, J. Kovačević, J. M. F. Moura and P. Vandergheynst, “Graph Signal Processing: Overview, Challenges, And Applications,” Proceedings of the IEEE, vol. 106, no. 5, pp. 808-828, 2018. The GFT is an extension of the classical Fourier Transform to a more general domain, that is, data residing on irregular graphs. Three dimensional mesh models are one example of such data. “Irregular” in this context means that each vertex in a mesh can be connected to a variable number of other vertices, such that the network of vertex connections across the mesh is irregular. Such a network can be described by a planar graph, denoted G=(V, E), where V denotes the set of mesh vertices (graph nodes) and E denotes the set of mesh edges (connections between the vertices). In practice, aspects disclosed herein are typically applied to a graph with simple connectivity (“simple” graph). A simple graph is a graph for which: the links between the different nodes are undirected: there are no multiple links between any pair of nodes: there are no loops around any node; and the graph links are unweighted.

Karni et al. showed how the GFT could be used to obtain a “spectral compression” of a 3D mesh geometry. See, Z. Karni and C. Gotsman, Spectral Compression of Mesh Geometry, in SIGGRAPH′00, New Orleans, Louisiana, USA, 2000 (“Karni”). Therein, it is assumed that the vertex location vectors of the 3D mesh geometry (considering separately the x, y, and z coordinates) may be expressed as a linear combination of a small number of orthogonal basis vectors. Such orthogonal basis vectors can be obtained by a combinatorial mesh Laplacian matrix (referred to herein as the “Laplacian matrix”). This is similar in principle to the transform coding technique used in the JPEG image compression standard, which is based on using discrete cosine transform (DCT) basis vectors to obtain more compact representations of the image's pixel data.

The computation of the Laplacian matrix, L, depends only on mesh (graph) connectivity. For a mesh with n vertices, L is a square n×n matrix that is computed as:

$$L = D - A , \qquad ( 4 )$$

where A is a symmetric “adjacency matrix” of n×n dimensions that contains, at each location (i, j) and (j, i) a value “1” if vertex i (i.e., vᵢ) is connected by an edge to vertex j (i.e., vⱼ) and a value “0” otherwise. D is a “degree matrix” of n×n dimensions that contains, on the main diagonal, the sum of the adjacency matrix values across the corresponding row (or column), and zeros in all the other locations. The value of a diagonal element i in D (that is, element (i, j=i)) is considered as the degree or valence of vertex i, denoted deg (vᵢ), which represents the number of edges connected to that vertex. The formal mathematical definition for L can be written as:

$$( {L}_{i , j} ) := \{ \begin{matrix}deg ( {v}_{i} ) & if i = j \\ - 1 & if i \neq j and {v}_{i} is adjacent to {v}_{j} \\ 0 & otherwise\end{matrix} \qquad ( 5 )$$

To obtain the basis vectors, the eigenvectors (n×1 column vectors) and the eigenvalues (n scalar) of the Laplacian matrix L are computed. The eigenvalues are then sorted in ascending order by their magnitude, and their corresponding eigenvectors are ordered accordingly. The normalized version of the ordered eigenvectors of L, namely, Laplacian eigenvectors, constitute orthonormal basis that is denoted herein by L_{eigenvectors}.

Taubin showed that the Laplacian eigenvectors, when computed based on connectivity information of a mesh, form an orthogonal basis for the vector space R″ (where n is the number of vertices of the mesh) and thus such orthogonal basis can be used to represent the mesh geometry data. See, G. Taubin, “A Signal Processing Approach to Fair Surface Design,” in SIGGRAPH′95, Los Angeles, California, USA, 1995. Representing the mesh geometry data by the Laplacian eigenvectors may be analogized with the representation provided by Fourier basis vectors, where respective eigenvalues can be analogized with respective frequencies associated with the Fourier basis vectors. Therefore, the arrangement of eigenvalues from lowest to highest magnitude, and the arrangement of their corresponding eigenvectors in the same order, effectively puts all the “lowest-frequency” basis vectors first, followed by increasingly “higher-frequency” basis vectors. Thus, eigenvectors that correspond to eigenvalues of zero can be considered as “DC” components (using the above analogy).

As demonstrated in Karni, each dimension of a mesh's geometry data—that is, each of the vertex location vectors X={x₁, x₂, . . . , xₙ}, Y={y₁, y₂, . . . , yₙ} and Z={z₁, z₂, . . . , zₙ}—can be projected onto the same set of Laplacian eigenvectors (basis vectors) by a matrix multiplication to obtain 3 sets of spectral coefficients (namely, GFT coefficients), each of which is a vector of size 1×n. For example, with respect to X and the corresponding set of spectral coefficients, each coefficient in the set indicates “how much” of the corresponding basis vector (eigenvector) is required to represent X as a linear combination of all the eigenvectors.

When encoding the GFT coefficients, since the coefficients are usually quantized prior to entropy coding, there will be some irreversible loss, resulting in lossy reconstruction (decoding) of the mesh geometry data. Nevertheless, the key strength of this transform coding method is that, for relatively smooth meshes, the resulting coefficients will have large magnitudes only for those corresponding to lower-frequency basis vectors, while the other coefficients will have values of zero or close to zero. Therefore, a good approximation of the original mesh can be obtained by coding only a portion of the coefficients (those correspond to lower-frequency basis vectors). Additionally, coding and transmitting (a portion or all) of the coefficients can be done, where a decoder can progressively improve the reconstructed mesh based on coefficients received so far. Thus, a graceful progressive reconstruction of the mesh geometry data (shape) is enabled at different quality levels (i.e., different levels of accuracy of the reconstruction of the mesh's vertex location vectors X, Y, and Z).

Since the computation of the Laplacian eigenvectors (that is, matrix L_{eigenvectors}) is independent of the mesh geometry, these eigenvectors can be computed independently at the decoder end based on the mesh's connectivity data. No indices have to be provided to the decoder for the ordering of the eigenvectors since the decoder can sort the eigenvalues and order the eigenvectors accordingly in the same manner that it has been done by the encoder. Note also that since the Laplacian eigenvectors are orthonormal and contain real values (no complex numbers), L_{eigenvectors} can be inverted by simply transposing it, that is, L_{eigenvectors}⁻¹=L_{eigenvectors}^{T}.

The main limitation of applying GFT to represent a mesh geometry (or other data associated with vertices of the mesh) is that it requires the computation of Laplacian eigenvectors at both the encoder and the decoder ends. Performing such computation for very large meshes (e.g., beyond several thousand vertices) can be both time-consuming and susceptible to numerical instabilities that can lead to unexpected results. However, such limitation may not be present when applying the GFT to small meshes such as base meshes, as disclosed in application no. EP22306565.7, titled Motion Coding for Dynamic Meshes Using Intra- and Inter-Frame Graph Fourier Transforms, the disclosure of which is incorporated by reference herein in its entirety. Moreover, as disclosed herein, such limitation may not be present when applying the GFT to small mesh patches that partition a larger mesh.

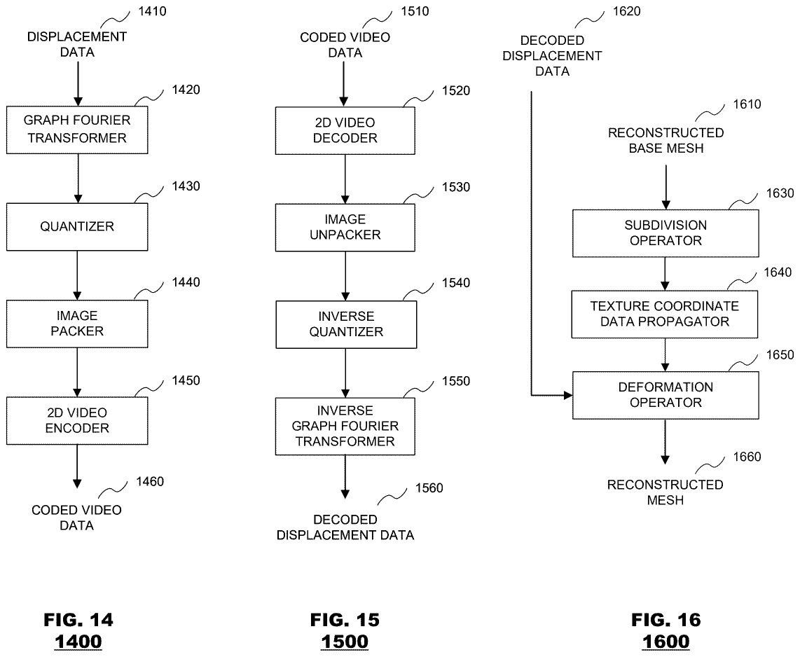

Aspects of the present disclosure disclose variants to the test model, namely various operational modes. In these aspects, instead of applying wavelet-based encoding and decoding to displacement data (see FIGS. 6-7), spectral-based encoding and decoding are applied to geometry data of the mesh (see FIGS. 9-10) as well as to displacement data (see FIGS. 14-15). Hence, aspects disclosed herein describe various operational modes in reference to FIGS. 9-22.

FIG. 9 is a functional block diagram of an example spectral-based encoder 900 (e.g., employable by the mesh encoder 245 of FIG. 2). The spectral-based encoder 900 generally encodes geometry data 910, associated with vertices of a given mesh, generated by applying displacement vectors to corresponding vertices of the subdivided base mesh, as further described below. To that end, a GFT is applied, by a graph Fourier transformer 920, to represent the vertex positions of the vertices of the given mesh, obtaining GFT coefficients. These GFT coefficients are then quantized, by a quantizer 930, using, for example, a uniform scalar quantizer with a dead-zone. Next, the quantized GFT coefficients are packed, by an image packer 940, into a 2D image. The 2D image is then encoded, by a 2D video encoder 950, generating coded video data 960. As mentioned above, the 2D video encoder 950 may implement any video encoding method in accordance with a specific application's requirements.

FIG. 10 is a functional block diagram of an example spectral-based decoder 1000 (e.g., employable by the mesh decoder 250, 340 shown in FIG. 2 and FIG. 3). The spectral-based decoder 1000 generally reverses the operation of the spectral-based encoder 900. Accordingly, the spectral-based decoder 1000 employs a 2D video decoder 1020 to decode a packed 2D image from the coded video data 1010 (generated by the 2D video encoder 950). Next, an image unpacker 1030 is employed to unpack the decoded 2D image to obtain the quantized GFT coefficients (generated by the quantizer 930). An inverse quantizer 1040 dequantizes the quantized GFT coefficients (generated by the graph Fourier transformer 920). The dequantized GFT coefficients are then inverse transformed by an inverse graph Fourier transformer 1050, generating decoded geometry data 1060, that is, decoded vertex positions of the vertices of the given mesh encoded by the spectral-based encoder 900.

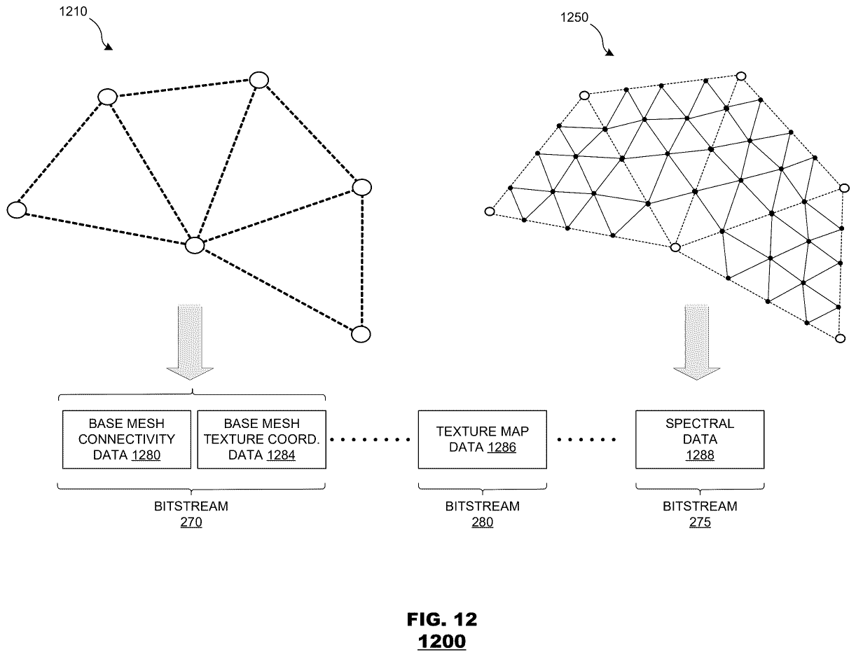

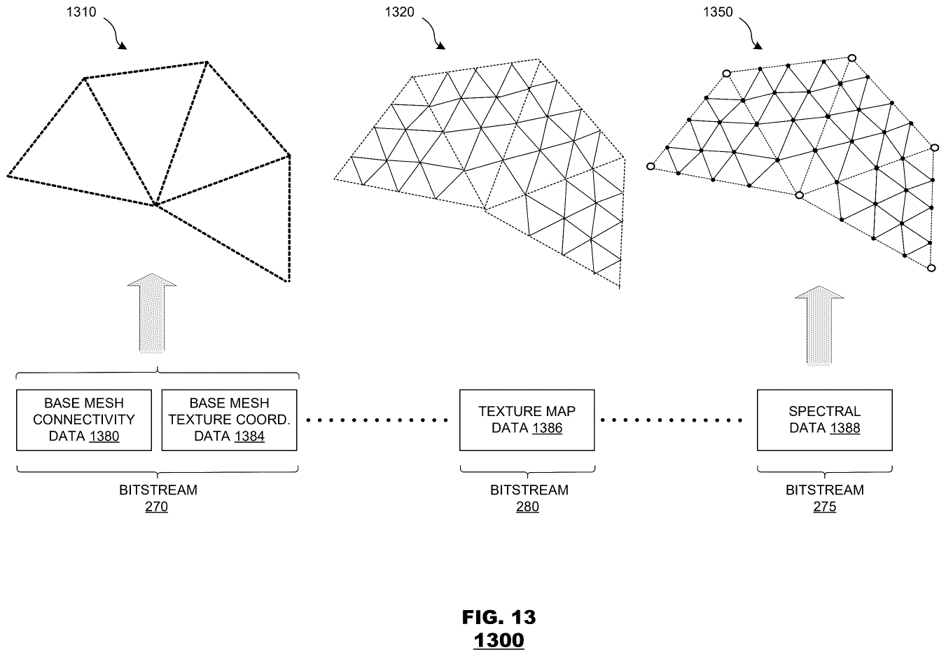

FIG. 11 is a functional block diagram of an example mesh reconstructor 1100 (e.g., employable by the mesh reconstructor 255, 360 shown in FIG. 2 and FIG. 3). The mesh reconstructor 1100 is configured to generate the reconstructed mesh 1150 based on the reconstructed base mesh 1110 and the decoded geometry data 1120. The decoded base mesh 1110 may include only connectivity data and texture coordinate data, as further discussed in reference to FIGS. 12 and 13. The decoded geometry data 1120 include the decoded vertex positions of vertices of the given mesh, encoded by the spectral-based encoder 900 and decoded by the spectral-based decoder 1000. Thus, to generate the reconstructed mesh 1150, connectivity data and texture coordinate data can be extracted from the reconstructed base mesh 1110. The base mesh connectivity is subdivided, by a subdivision operator 1130 (using the same subdivision scheme used during the encoding process) providing the connectivity of a subdivided base mesh. The texture coordinate data (mapping parameters associated with vertices originated from the base mesh) are then propagated, by a texture coordinate data propagator 1140, to the remaining vertices of the subdivided base mesh. The combined data, including the decoded geometry data 1120, the subdivided base mesh connectivity, and the propagated texture coordinate data, constitute the reconstructed mesh 1150.

In a first operational mode, spectral-based coding 900 is utilized to code the full geometry of the mesh. As described above, in the test model, wavelet coefficients are used to represent the displacement vectors 224 (the spatial difference between a subdivided base mesh and a mesh M(i) that is to be encoded). Alternatively, as disclosed herein, the displacement vectors 224 can be applied to respective vertices of the subdivided base mesh, displacing their vertex positions to spatially reach corresponding vertices of the M(i). These displaced vertices, constituting a full mesh, can be spectral-based encoded 920. In this first mode, only the topology (connectivity) of the base mesh has to be encoded into the bitstream 270; there is no need in this mode for the base mesh encoder 235 to encode the base mesh geometry into the bitstream 270 as this information is already encoded by the spectral-based encoder 900, as described further below. Any coding technique that does not couple between the coding of the mesh geometry and the coding of the mesh connectivity (so that the former is not required for the reconstruction of the latter) can be used by the base mesh encoder 235 (such as EdgeBreaker). Thus, according to this first mode of operation, the base mesh encoder 235 encodes the connectivity of the base mesh into the bitstream 270 and the mesh encoder 245 encodes the geometry of the full mesh into the bitstream 275 employing spectral-based encoding 900.

Note that in the test model, when the motion encoder 450 is employed, motion encoding is only applied to the geometry of the base mesh and that the base mesh's topology (connectivity) is not encoded. In the first mode of operation, since encoding of the base mesh connectivity is required, the motion encoder 450 should not be employed (motion encoding is disabled). However, by packing the quantized spectral coefficients into images 940 and using a video encoder for their compression 950, compression gain is obtained through the video encoder motion estimation. Thus, in aspects of the first mode of operation, the base mesh encoder 400 and decoder 500 only perform intra encoding—that is, the static mesh encoder 440 and decoder 540 are selected to encode the base mesh data.

FIG. 12 illustrates an example of spectral-based encoding in the first operational mode 1200. As illustrated, a base mesh 1210 is associated with connectivity data (marked by dashed lines), and each vertex of the base mesh is associated with position coordinates (marked by hollow circles) and texture coordinates (not shown). In an aspect, the base mesh connectivity data 1280 and the base mesh texture coordinate data 1284 (texture coordinates) are encoded into the bitstream 270, but not the base mesh geometry data (position coordinates). Following subdivision of the base mesh (e.g., by the mesh decomposer 220) and the application of the displacement vectors (e.g., by the mesh encoder 245) to obtain the full mesh M(i) 1250, spectral-based coding 900 is performed to encode the geometry data associated with the vertices of the full mesh 1250. Specifically, the operation of the graph Fourier transformer 920 is as follows.

The graph Fourier transformer 920 first obtains the orthonormal basis vectors, L_{eigenvectors}, based on the connectivity of the full mesh M(i) 1250 (as described in reference to equations 4 and 5), denoted L_{M}. For each frame, the geometry data associated with the n vertices of M(i) 1250—that is, X_{M(i)}={x₁, x₂, . . . , xₙ} Y_{M(i)}={y₁, y₂, . . . , yₙ}, and Z_{M(i)}={z₁, z₂, . . . , zₙ})—are projected onto L_{M} to obtain the GFT coefficients (CX_{M(i)}, CY_{M(i)}, CZ_{M(i)}), as follows:

$${CX}_{M ( i )} = {X}_{M ( i )} \times {L}_{M} \qquad ( 6 )$$

$${CY}_{M ( i )} = {Y}_{M ( i )} \times {L}_{M}$$

$${CZ}_{M ( i )} = {Z}_{M ( i )} \times {L}_{M} ,$$

where operator × indicates matrix multiplication, L_{M} is an n×n matrix where each column represents one eigenvector (basis vector), and the GFT coefficients in CX_{M(i)}, CY_{M(i)}, and CZ_{M(i)} are each a vector of size 1×n. The computed GFT coefficients are encoded by the spectral based encoder 900—that is, these coefficients, generated by the graph Fourier transformer 920, are quantized 930, packed into images 940, and encoded by the video encoder 950 into coded video data 960, representing the spectral data 1288 that are to be added to the bitstream 275. As shown, texture map data 1286 also added to the bitstream 280 by the attribute map encoder 260.

FIG. 13 illustrates an example of spectral-based decoding in the first operational mode 1300. As illustrated, the base mesh connectivity data 1380 are extracted from the bitstream 270 and the base mesh connectivity 1310 is decoded therefrom. The base mesh connectivity 1310 is subdivided (using the same subdivision scheme used at the encoder end) to obtain the connectivity of the full mesh 1320. Then, to reconstruct geometry data 1060 associated with the vertices of the full mesh 1350 (marked by hollow and full circles), the spectral-based decoder 1000 is employed to decode the spectral data 1388 extracted from the bitstream 275 (coded video data 1010). Accordingly, the coded video data 1010 are video decoded 1020, and unpacked 1030. Then, the resulting quantized GFT coefficients are inverse quantized 1040 and inverse transformed 1050 to obtain the decoded geometry data 1060. Specifically, the operation of the inverse graph Fourier transformer 1050 is as follows.

The inverse graph Fourier transformer 1050 first obtains the orthonormal basis vectors L_{M}, as described above with respect to FIG. 12. Next, the geometry data associated with the vertices of M(i) 1320 are recovered. That is, vertex positions \hat{X}_{M(i)}, Ŷ_{M(i)}, and \hat{Z}_{M(i)} are computed by linearly combining the decoded GFT coefficients [symbol] _{M(i)}, [symbol] _{M(i)}, [symbol] _{M(i)} with corresponding Laplacian eigenvectors in L_{M}^{T} as follows:

$${\hat{X}}_{M ( i )} = {M ( i )}_{} \times {L}_{M}^{T} \qquad ( 7 )$$

$${\hat{Y}}_{M ( i )} = {M ( i )}_{} \times {L}_{M}^{T}$$

$${\hat{Z}}_{M ( i )} = {M ( i )}_{} \times {L}_{M}^{T} ,$$

where operator × indicates matrix multiplication and where operator T indicates matrix transpose. Next, the base mesh texture data 1384 can be extracted from the bitstream 270 and texture coordinates associated with vertices of the base mesh 1310 can be decoded therefrom. Then, the decoded texture coordinates of vertices of the base mesh 1310 can be used (e.g., interpolated) to generate texture coordinates of the remaining vertices in the full mesh 1350 (see FIG. 11). As shown, the texture map data 1386 also decoded from the bitstream 280 by the attribute map encoder 260.

Hence, when employing aspects of the first mode of operation, the encoder 230 can signal in the bitstream to the decoder 330 that the first mode is used. In contrast to the test model, geometry data of the base mesh need not be encoded into the bitstream 270. Rather, in aspects of the first mode, only the connectivity of the base mesh (base mesh connectivity data 1280) and the texture coordinates (base mesh texture coordinate data 1284) are encoded by the base mesh encoder 235 into the bitstream 270. Instead of wavelet coefficients that represent displacement data, GFT coefficients that represent the geometry data of the full mesh (spectral data 1288) are encoded 245 into the bitstream 275.

In a second operational mode, the spectral-based coding and decoding are applied to displacement data. That is, displacement vectors d′(i)—dX_{M(i)}={dx₁, dx₂, . . . , dxₙ}, dY_{M(i)}={dy₁, dy₂, . . . , dyₙ}, and dZ_{M(i)}={dz₁, dz₂, . . . , dzₙ})—are fed into equation (6) to obtain the GFT coefficients, that, when fed into equation (7), provide the reconstructed displacement vectors d″(i)— [symbol] _{M(i)}={dx₁, dx₂, . . . , dxₙ}, [symbol] _{M(i)}={dy₁, dy₂, . . . , dyₙ}, and [symbol] _{M(i)}={dz₁, dz₂, . . . , dzₙ}). Where a displacement vector (dyᵢ, dyᵢ, dzᵢ) represents the spatial distance between vertex vᵢ of the subdivided base mesh to corresponding vertex of M(i). Hence, in this mode, the encoder 230 signals in the bitstream to the decoder 330 that this second operational mode is used.

Accordingly, at the encoder 230, as illustrated in FIG. 14, a spectral-based encoder 1400 (e.g., employable by the mesh encoder 245 of FIG. 2) can be applied to the displacement data, that is, dX_{M(i)}, dY_{M(i)}, and dZ_{M(i)}. Thus, the displacement data 1410 are transformed 1420 into GFT coefficients. Then, the coefficients are quantized 1430, packed 1440, and video encoded 1450, generating coded video data 1460. At the decoder 330, as illustrated in FIG. 15, a spectral-based decoder 1500 (e.g., employable by the mesh decoder 340 of FIG. 3) can be applied. The spectral-based decoder 1500 generally reverses the operation of the spectral-based encoder 1400. Thus, the spectral-based decoder 1500 employs a 2D video decoder 1520 to decode a packed 2D image from the coded video data 1510 (generated by the 2D video encoder 1450). Next, an image unpacker 1530 is employed to unpack the decoded 2D image to obtain the quantized GFT coefficients (generated by the quantizer 1430). An inverse quantizer 1540 dequantizes the quantized GFT coefficients (generated by the graph Fourier transformer 1420). The dequantized GFT coefficients are then inverse transformed by an inverse graph Fourier transformer 1550, generating decoded displacement data 1560, that is, the reconstructed displacement vectors [symbol] _{M(i)}; [symbol] _{M(i)}, and [symbol] _{M(i)}.

In this second mode of operation, to facilitate the reconstruction of the geometry data of the full mesh M(i), that is, reconstructed vertex positions, \hat{X}M(i), ŶM(i), and \hat{Z}M(i), the geometry data of the base mesh have to be encoded into the bitstream 270. FIG. 16 illustrates mesh reconstruction 1600 (e.g., employable by the mesh reconstructor 255, 360 shown in FIG. 2 and FIG. 3). To generate the reconstructed mesh DM(i) 1660, geometry, connectivity, and texture coordinate data can be extracted from the reconstructed base mesh 1610. Then, the base mesh connectivity is subdivided, by a subdivision operator 1630 (using the same subdivision scheme used during the encoding process) generating a subdivided base mesh whose vertex positions are interpolated based on vertex positions of the vertices of the reconstructed base mesh 1610. The texture coordinate data (mapping parameters associated with vertices that originated from the base mesh) are then propagated, by a texture coordinate data propagator 1640, to the remaining vertices in the subdivided base mesh. The decoded displacement data 1620—that is, reconstructed displacement vectors [symbol] _{M(i)}, [symbol] _{M(i)}, and [symbol] _{M(i)}—are then applied to the subdivided base mesh by a deformation operator 1650, in effect deforming the subdivided base mesh to obtain the reconstructed mesh 1660—that is, reconstructed vertex positions \hat{X}_{M(i)}, Ŷ_{M(i)}, and \hat{Z}_{M(i)}.

In a third operational mode, motion encoding 450 is employed (motion encoding is enabled 1485, 1585) along with static mesh encoding 440 (as described in reference to FIG. 4 and FIG. 5). In this mode, geometry data of a reduced mesh (including vertex positions of vertices of the full mesh that were not originated from the base mesh) are encoded and decoded, respectively, by the spectral-based encoder 900 and spectral-based decoder 1000, as described further below.

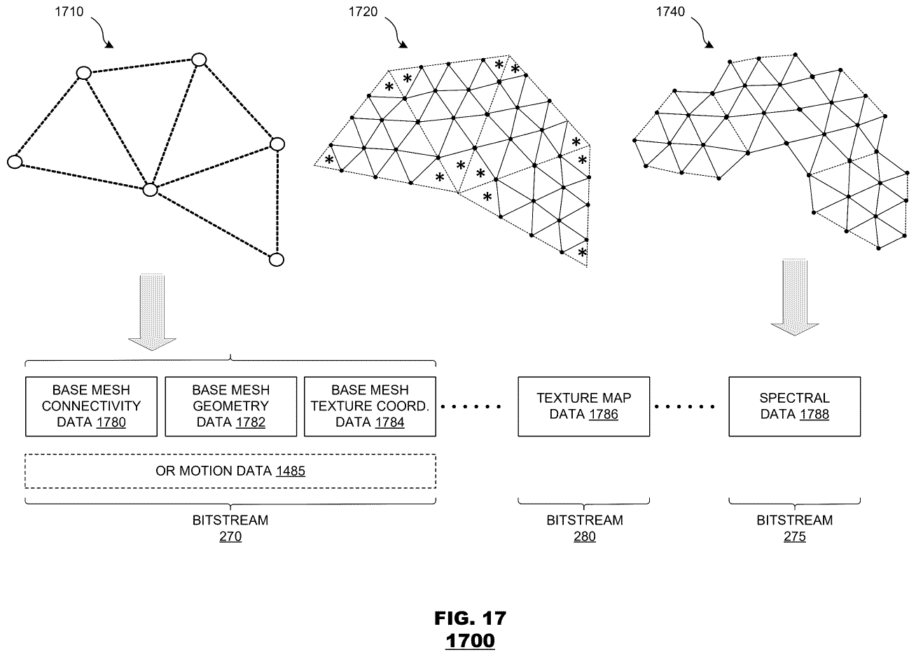

FIG. 17 illustrates an example of spectral-based encoding in the third operational mode 1700. As illustrated, a base mesh 1710 is associated with connectivity data (marked by dashed lines), and each vertex of the base mesh is associated with position coordinates (marked by hollow circles) and texture coordinates (not shown). In an aspect, the base mesh connectivity data 1780, the base mesh geometry data 1782 (position coordinates) and the base mesh texture coordinate data 1784 (texture coordinates) are encoded into the bitstream 270. Following subdivision of the base mesh (e.g., by the mesh decomposer 220) and the application of the displacements (e.g., by the mesh encoder 245), the obtained full mesh M(i) 1720 is reduced. That is, vertices that were originated from the base mesh and the faces (triangles) connected to these vertices (marked by *) are removed to obtain a reduced mesh 1740, denoted M_{R}(i). Spectral-based coding 900 is then performed to encode the geometry data associated with the vertices of the reduced mesh M_{R}(i) 1740. Specifically, the operation of the graph Fourier transformer 920 is as follows.

The graph Fourier transformer 920 first obtains the orthonormal basis vectors, L_{eigenvectors}, based on the connectivity of the reduced mesh M_{R}(i) 1740 (as described in reference to equations 4 and 5), denoted L_{M}_{_{R}}. For each frame, the geometry data associated with the n vertices of M_{R}(i) 1740—that is, X_{M}_{_{R}}₍ᵢ₎={x₁, x₂, . . . , xₙ}, Y_{M}_{_{R}}₍ᵢ₎={y₁, y₂, . . . , yₙ} and Z_{M}_{_{R}}₍ᵢ₎={z₁, z₂, . . . , zₙ})—are projected onto L_{M}_{_{R}} to obtain the GFT coefficients (CX_{M}_{_{R}}₍ᵢ₎; CY_{M}_{_{R}}₍ᵢ₎, CZ_{M}_{_{R}}₍ᵢ₎), as follows:

$${CX}_{{M}_{R} ( i )} = {X}_{{M}_{R} ( i )} \times {L}_{{M}_{R}} \qquad ( 8 )$$

$${CY}_{{M}_{R} ( i )} = {Y}_{{M}_{R} ( i )} \times {L}_{{M}_{R}}$$

$${CZ}_{{M}_{R} ( i )} = {Z}_{{M}_{R} ( i )} \times {L}_{{M}_{R}} ,$$

where operator × indicates matrix multiplication, L_{M}_{_{R}} is an n×n matrix where each column represents one eigenvector (basis vector), and the GFT coefficients in CX_{M}_{_{R}}₍ᵢ₎; CY_{M}_{_{R}}₍ᵢ₎, and CZ_{M}_{_{R}}₍ᵢ₎ are each a vector of size 1×n. The computed GFT coefficients are encoded by the spectral based encoder 900—that is, these coefficients, generated by the graph Fourier transformer 920, are quantized 930, packed into images 940, and encoded by a video encoder 950 into coded video data 960, representing the spectral data 1788 that are added to the bitstream 275. As shown, a texture map data 1786 are also added to the bitstream 280 by the attribute map encoder 260.

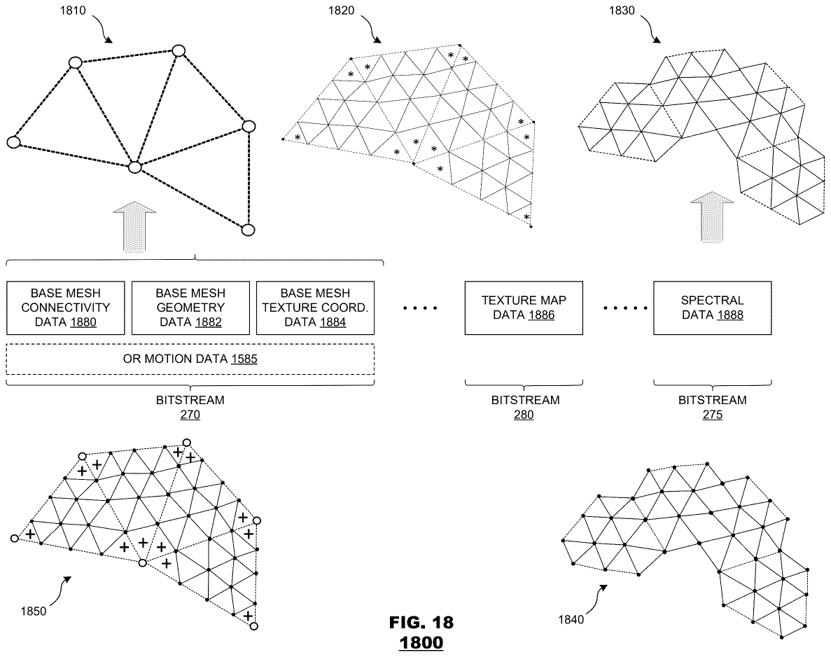

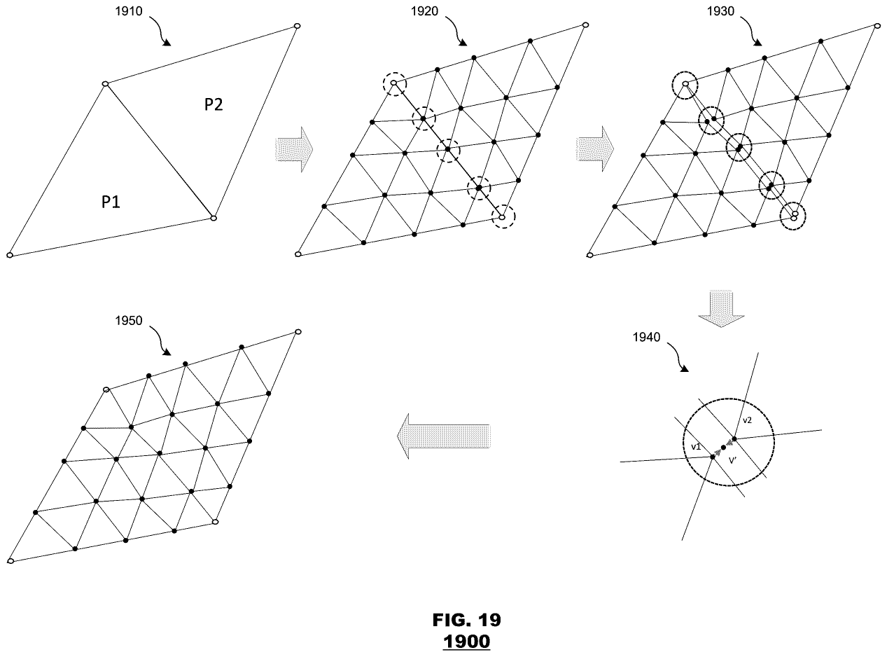

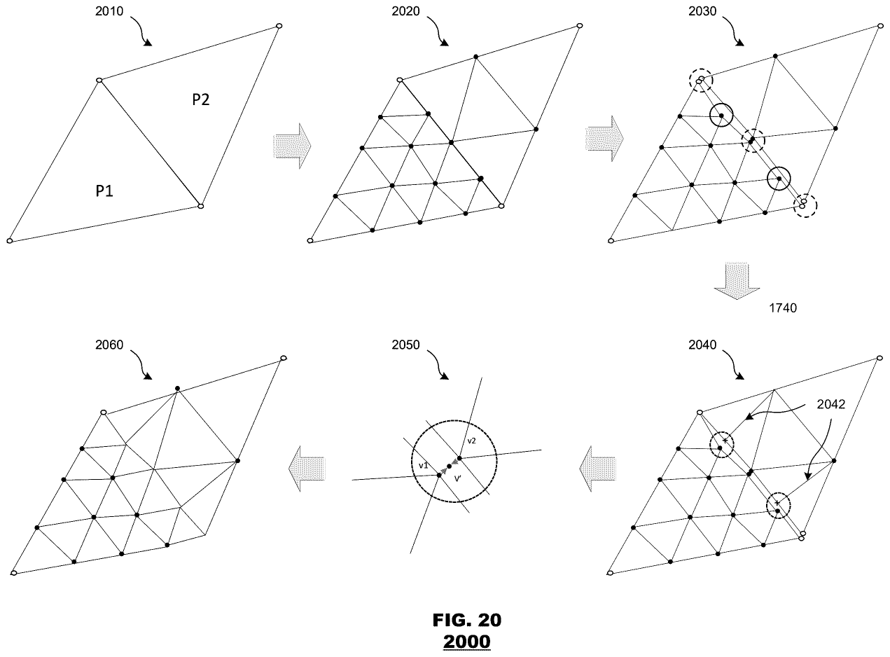

FIG. 18 illustrates an example spectral-based decoding in the third operational mode 1800. As illustrated, the base mesh connectivity data 1880 as well as the base mesh geometry data 1882 are extracted from the bitstream 270, and then the base mesh 1810 is reconstructed therefrom. The base mesh 1810 is subdivided (using the same subdivision scheme used by the encoder) to obtain the connectivity of the full mesh 1820, including only positional data associated with vertices originated from the base mesh (marked by full circles in 1820). Then, removing triangles that are connected to vertices that originated from the base mesh (marked by *), the mesh 1820 is reduced into a reduced mesh M_{R}(i) 1830 (in the same manner it was performed during the encoding to generate the reduced mesh 1740). To reconstruct the geometry data associated with the vertices of the reduced mesh M_{R}(i) 1830, the spectral-based decoder 1000 is employed to decode the spectral data 1888 extracted from the bitstream 275 (coded video data 960, 1010). Accordingly, the coded video data 1010 are video decoded 1020 and unpacked 1030. The resulting quantized GFT coefficients are then inverse quantized 1040 and inverse transformed 1050 to obtain the decoded geometry data 1060. Specifically, the operation of the inverse graph Fourier transformer 1050 is as follows.

The inverse graph Fourier transformer 1050 first obtains the orthonormal basis vectors L_{M}_{_{R}}: as described above with respect to FIG. 17. Next, the geometry data associated with the vertices of M_{R}(i) are recovered (marked by circles in 1840). That is, the vertex positions of the reduced mesh 1840 are computed by linearly combining the decoded GFT coefficients [symbol] _{M}_{_{R}}₍ᵢ₎, [symbol] _{M}_{_{R}}₍ᵢ₎, [symbol] _{M}_{_{R}}₍ᵢ₎ with corresponding Laplacian eigenvectors in L_{M}_{_{R}}^{T} as follows:

$${\hat{X}}_{{M}_{R} ( i )} = {{M}_{R} ( i )}_{} \times {L}_{{M}_{R}}^{T} \qquad ( 9 )$$

$${\hat{Y}}_{{M}_{R} ( i )} = {{M}_{R} ( i )}_{} \times {L}_{{M}_{R}}^{T}$$

$${\hat{Z}}_{{M}_{R} ( i )} = {{M}_{R} ( i )}_{} \times {L}_{{M}_{R}}^{T} ,$$

where operator × indicates matrix multiplication and where operator T indicates matrix transpose. Once the coordinates of the vertices of the reduced mesh M_{R}(i) are reconstructed—that is, \hat{X}_{M}_{_{R}}₍ᵢ₎, Ŷ_{M}_{_{R}}₍ᵢ₎, and \hat{Z}_{M}_{_{R}}₍ᵢ₎-vertices from the base mesh can be reconnected to the reconstructed reduced mesh to obtain the reconstructed full mesh 1850 (the regenerated triangles are marked by +). Next, the base mesh texture coordinate data 1884 can be extracted from the bitstream 270 and texture coordinates associated with the vertices of the base mesh 1810 can be decoded therefrom. The decoded texture coordinates of the vertices of the base mesh 1310 can be used (e.g., interpolated) to generate the texture coordinates of the remaining vertices in the full mesh 1850 (see FIG. 11). As shown, the texture map data 1886 also decoded from the bitstream 280 by the attribute map encoder 260.

Hence, when employing aspects of the third mode of operation, the encoder 230 can signal in the bitstream to the decoder 330 that the third mode is used. In this case, the base mesh encoder 235 and the base mesh decoder 240 operate as described in reference to FIG. 4 and FIG. 5, respectively. However, instead of wavelet coefficients that represent displacement data, GFT coefficients that represent the geometry data of the reduced mesh 1740 (spectral data 1788) are encoded 245 into the bitstream 275.

In a fourth operational mode, the spectral-based coding and decoding are applied to displacement data. That is, displacement vectors d′(i)—dX_{M}_{_{R}}₍ᵢ₎={dx₁, dx₂, . . . , dxₙ}, dY_{M}_{_{R}}₍ᵢ₎={dy₁, dy₂, . . . , dyₙ}, and dZ_{M}_{_{R}}₍ᵢ₎={dz₁, dz₂, . . . , dzₙ})—are fed into equation (8) to obtain the GFT coefficients, that, when fed into equation (9), provide the reconstructed displacement vectors d″(i): [symbol] _{M}_{_{R}}₍ᵢ₎={dx₁, dx₂, . . . , dxₙ}, [symbol] _{M}_{_{R}}₍ᵢ₎={dy₁, dy₂, . . . , dyₙ}, and [symbol] _{M}_{_{R}}₍ᵢ₎={dz₁, dz₂, . . . , dzₙ}). Where a displacement vector (dyᵢ, dyᵢ, dzᵢ) represents the spatial distance between vertex vᵢ from the subdivided base mesh to corresponding vertex of M(i). Hence, in this mode, the encoder 230 signals in the bitstream to the decoder 330 that the fourth operational mode is used.

Accordingly, at the encoder end 200, as illustrated in FIG. 14, a spectral-based encoder 1400 (e.g., employable by the mesh encoder 245 of FIG. 2) can be applied to the displacement data, dX_{M}_{_{R}}₍ᵢ₎, dY_{M}_{_{R}}₍ᵢ₎, and dZ_{M}_{_{R}}₍ᵢ₎. Thus, the displacement data 1410 are transformed 1420 into GFT coefficients, and then the coefficients are quantized 1430, packed 1440, and video encoded 1450, generating coded video data 1460. At the decoder 330, as illustrated in FIG. 15, a spectral-based decoder 1500 (e.g., employable by the mesh decoder 340 of FIG. 3) can be applied. The spectral-based decoder 1500 generally reverses the operation of the spectral-based encoder 1400. Thus, the spectral-based decoder 1500 employs a 2D video decoder 1520 to decode a packed 2D image from the coded video data 1510 (generated by the 2D video encoder 1450). Next, an image unpacker 1530 is employed to unpack the decoded 2D image to obtain the quantized GFT coefficients (generated by the quantizer 1430). An inverse quantizer 1540 dequantizes the quantized GFT coefficients (generated by the graph Fourier transformer 1420). The dequantized GFT coefficients are then inverse transformed by an inverse graph Fourier transformer 1550, generating decoded displacement data 1560, that is, the reconstructed displacement vectors [symbol] _{M}_{_{R}}₍ᵢ₎: [symbol] _{M}_{_{R}}₍ᵢ₎, and [symbol] _{M}_{_{R}}₍ᵢ₎.

The geometry data of the reduced mesh M_{R}(i) are reconstructed next, obtaining reconstructed vertex positions \hat{X}_{M}_{_{R}}₍ᵢ₎, Ŷ_{M}_{_{R}}₍ᵢ₎, and \hat{Z}_{M}_{_{R}}₍ᵢ₎. FIG. 16 illustrates mesh reconstruction 1600 (e.g., employable by the mesh reconstructor 255, 360 shown in FIG. 2 and FIG. 3). To generate the reconstructed mesh DM(i) 1660, geometry, connectivity, and texture coordinate data can be extracted from the reconstructed base mesh 1610. Then, the base mesh connectivity is subdivided, by a subdivision operator 1630 (using the same subdivision scheme used during the encoding process) generating a subdivided base mesh whose vertex positions are interpolated based on the vertex positions of the vertices of the reconstructed base mesh 1610. The texture coordinate data (mapping parameters associated with vertices originated from the base mesh) are then propagated, by a texture coordinate data propagator 1640, to the remaining vertices in the subdivided base mesh. The decoded displacement data 1620—that is, reconstructed displacement vectors [symbol] _{M}_{_{R}}₍ᵢ₎, [symbol] _{M}_{_{R}}₍ᵢ₎, and [symbol] _{M}_{_{R}}₍ᵢ₎—are then applied to the subdivided base mesh by a deformation operator 1650, in effect deforming the subdivided base mesh to obtain the reconstructed mesh 1660—that is, reconstructed vertex positions \hat{X}_{M}_{_{R}}₍ᵢ₎; Ŷ_{M}_{_{R}}₍ᵢ₎, and \hat{Z}_{M}_{_{R}}₍ᵢ₎.

According to aspects described below, the mesh can be partitioned into patches to reduce the computational complexity of the spectral encoding. These aspects can be used to extend operations under the various modes described above, that is, partitioning into patches the full mesh 1250 (under the first or the second mode of operation) or partitioning into patches the reduced mesh 1740 (under the third or the fourth mode of operation).

As described in reference to equations 4 and 5, to obtain the orthonormal basis vectors, L_{M} or L_{M}_{_{R}}, eigenvectors and eigenvalues must be computed. The complexity of such a computation is proportional to the number n of mesh vertices involved—that is, the n×n dimensions of the Laplacian matrix, L, whose eigenvectors and eigenvalues are computed. The larger the number of mesh vertices n is, the higher the computational complexity and the susceptibility to numerical instabilities of the eigenvectors and eigenvalues computation are. Such computation can be very costly in processor cycles and memory accesses, and, therefore, limits the size of meshes for which using spectral coding is practical. Moreover, since the computation of the orthonormal basis vectors needs to be done at the decoder end too, such a process has to be sufficiently fast to allow for proper play back of the dynamic mesh frames, for example.

To reduce the computational complexity of the spectral encoding, in Karni, it is proposed to apply spectral encoding to mesh patches. However, separate spectral-based coding of two neighboring patches will most likely not lead to the same decoded vertex positions for corresponding vertices along the boundary that connects the two patches (a common edge). This is because the patches may have different basis vector sets due to differences in their respective connectivity. Thus, because the basis vector sets are not identical (and because of other factors such as spectral coefficients quantization) the recovered vertex positions of corresponding vertices along the boundary between two patches may be creating a spatial gap in the mesh surface representation. To overcome such a gap in the mesh surface representation, corresponding vertices along common edges have to be stitched. Techniques for partitioning a mesh to be encoded into patches and stitching the reconstructed mesh patches are disclosed herein in reference to FIG. 19 and to FIG. 20.

FIG. 19 illustrates an example of stitching mesh patches 1900. This stitching process 1900 is employable, for example, by the mesh reconstructor 255 of FIG. 2). Therein each face of the base mesh constitutes a mesh patch, for example, the illustrated patch P₁ and patch P₂ of a base mesh 1910. In this example, each of these patches is subdivided at the same subdivision depth, forming the subdivided base mesh 1920. As illustrated, the two patches share boundary vertices along the common edge that connects them (see shared vertices marked by dashed circles). Following reconstruction at the decoder end, the two patches (of the reconstructed mesh 1930) contain reconstructed boundary vertex positions (marked by circles) that form a gap that is caused by the independent spectral coding and decoding of P₁ and of P₂. As illustrated by the close up view 1940, the recovered positions of vertex v₁ of patch P₁ and corresponding vertex v₂ of patch P₂ are spatially apart. To stitch the patches of the reconstructed mesh 1930, corresponding vertices from neighboring patches (such as vertex 11 and corresponding vertex v₂) are replaced by a new vertex (denoted, v′) that is located at a new position that can be derived from the reconstructed positions of the corresponding vertices, resulting in a gap-free reconstructed mesh 1950.

Following the separate spectral coding and decoding of each of the patches, to stitch the reconstructed patches, corresponding vertices along common edges are combined into a new vertex. The position of the new vertex can be derived from the reconstructed positions of the corresponding vertices (for example, by a linear or quadratic interpolation) or it can be derived from the reconstructed positions of vertices in the spatial neighborhood of the corresponding vertices. The corresponding vertices may include two vertices along a shared edge or may include more than two vertices when the vertices are originated from the base mesh. However, corresponding vertices may include only two vertices, if the third or fourth mode of operation is used since in this case vertices that are originated from the base mesh are removed and so are not encoded by the spectral encoding process (see, reduced mesh 1740) of FIG. 17). Note that if corresponding vertices that are combined by the stitching process are not associated with the same texture coordinates, the corresponding vertices are merged into one vertex with a single position and multiple sets of texture coordinates; and if the corresponding vertices are associated with the same (or nearly the same) texture coordinates, the corresponding vertices are merged into one vertex with a single position and a single set of texture coordinates.

As described above, the base mesh is utilized as a basis for splitting the mesh into patches, each of which is derived from one face (triangle) of the base mesh. Given the base mesh connectivity, the connectivity of patches is known—that is, the common edges and vertices by which patches are connected are known. Furthermore, using the same subdivision scheme for all the patches, the corresponding vertices across a common edge between two connected patches are also known. Moreover, since in this aspect all patches have the same connectivity (due to the common subdivision depths), the same orthonormal basis vectors, denoted L_{P}, can be used to generate the GFT coefficients 920 at the encoder and to inverse them 1050 at the decoder.

Hence, the encoder can signal in the bitstream to the decoder that the mesh is encoded in patches as described above in reference FIG. 19. At the encoder, the faces of the base mesh are subdivided according to a given depth, forming mesh patches: the given depth is also signaled to the decoder. If the third mode or the fourth mode of operation is used, patches are reduced, removing vertices that originated from the base mesh, as described in reference FIGS. 17-18. Next, each patch is spectral-based encoded 900. At the decoder, the faces of the reconstructed base mesh are subdivided according to the signaled depth, forming mesh patches. Spectral-based decoding 900 is next performed with respect to each patch. Then, stitching is applied to corresponding vertices along common edges of the patches, as described above. Since in this case the patches' connectivity is the same, only one basis vector set has to be computed for the spectral-based encoding 900 and decoding 1000.

FIG. 20 illustrates a second example of stitching mesh patches 2000. This stitching process 2000 is employable, for example, by the mesh reconstructor 255 of FIG. 2. As before, each face of the base mesh constitutes a mesh patch, for example, the illustrated patches P₁ and P₂ of a base mesh 2010. However, in this example, patches may be subdivided at different subdivision depths 2020. Following subdivision, note that three new vertices introduced into patch P₁ along the common edge, while only one of these new vertices is shared with patch P₂. During reconstruction at the decoder end 2030, the reconstructed positions of vertices along the common edge form a gap that is caused by the independent spectral coding and decoding of patch P₁ and patch P₂. However, in this case, not all boundary vertices have respective corresponding vertices. Thus, only pairs of corresponding vertices (marked by dashed circles in 2030) can be stitched 2050, as described in reference to FIG. 19. With respect to the remaining boundary vertices from patch P₁ (marked by full circles in 2030), corresponding vertices can be created by locally tessellating 2042 patch P₂. Thus, the created vertices from patch P₂ (marked by + in 2040) form corresponding vertices to their counterparts from patch P₁ (marked by circles in 2040) that can be stitched 2050, as described in reference to FIG. 19. The vertex positions of the newly created vertices (marked by + in 2040) can be interpolated (e.g., linearly or quadratically) from the vertex positions of their parent vertices in the patch's subdivision. Thus, in this aspect, local subdivision 2042 is performed at the decoder end to locally match the subdivision depth of two reconstructed patches. This local adaptation of subdivision depth allows for vertices from one patch to have corresponding vertices from a second patch along these patches common edge. The resulting corresponding vertices can then be stitched to obtain a gap-free reconstructed mesh 2060.

Hence, the encoder can signal in the bitstream to the decoder that the mesh is encoded in patches as described above in reference to FIG. 20. At the encoder, the faces of the base mesh are subdivided according to respective depths, forming mesh patches: the respective depths are also signaled to the decoder. If the third mode or the fourth mode of operation is used patches are reduced, removing vertices that originated from the base mesh, as described in reference FIGS. 17-18. Then, each patch is spectral-based encoded 900. At the decoder, the faces of the reconstructed base mesh are subdivided according to the signaled respective depths, forming mesh patches. Spectral-based decoding 900 is next performed with respect to each patch. Then, local adaptation is performed so that common edges of the patches have the same number of vertices, and stitching is applied to corresponding vertices along the common edges, as described above. Note that in this aspect, patches with different subdivision depths (that is, different connectivity) have different orthonormal basis vector sets, and so these orthonormal basis vector sets have to be computed for spectral-based encoding 900 and decoding 1000.

In an aspect, local tessellation can be performed at the encoder end to obtain better encoding quality. However, in this approach, more vertices need to be encoded. Additionally, the connectivity of the patches may have larger variations, each of which will require computation of respective orthonormal basis vector set. In this aspect, the encoder can signal in the bitstream to the decoder that local tessellation was performed by the encoder. At the encoder, the faces of the base mesh are subdivided according to respective depths, forming mesh patches: the respective depths are also signaled to the decoder. If the third mode or the fourth mode of operation is used, boundary patches are reduced, removing vertices that originated from the base mesh, as described in reference FIGS. 17-18. Local adaptation is performed so that common edges of the patches have the same number of vertices, as described above. Then, each patch is spectral-based encoded 900. At the decoder, the faces of the reconstructed base mesh are subdivided according to the signaled respective depths, forming mesh patches. Next, in the same manner as done at the encoder, local adaptation is performed so that common edges of the patches have the same number of vertices. Spectral-based decoding is next performed with respect to each patch, and a stitching is applied to corresponding vertices along common edges of patches, as described above. Note that in this aspect, patches with different connectivity have different orthonormal basis vector sets, and so these orthonormal basis vector sets have to be computed for spectral-based encoding 900 and decoding 1000.

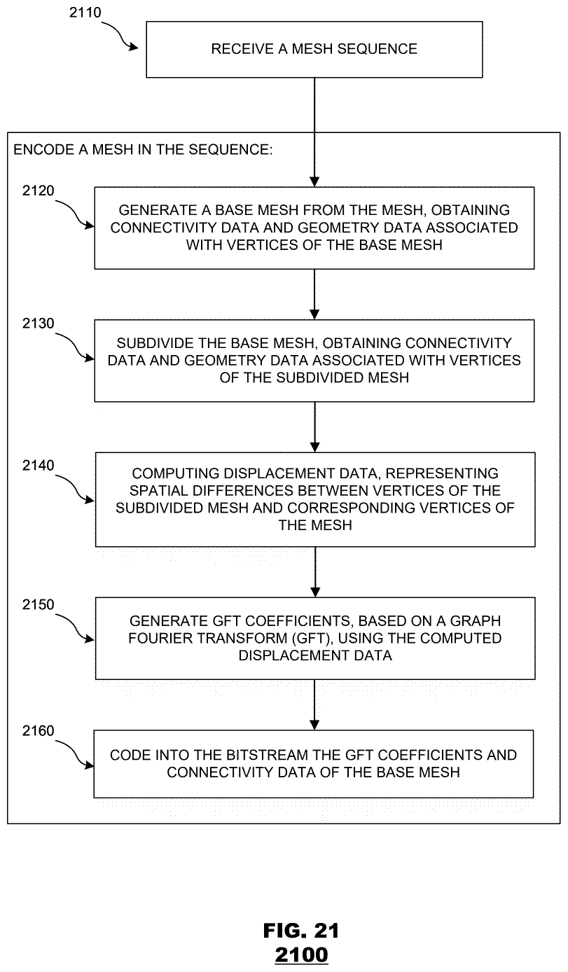

FIG. 21 is a flow diagram of an example method for encoding mesh data 2100. The method 2100 begins, in step 2110, by receiving a mesh sequence. For each of the meshes in the sequence, the method 2100 proceeds with the coding according to steps 2120-2160. Thus, in step 2120, a base mesh is generated from the mesh that is to be coded, obtaining connectivity data and geometry data associated with vertices of the base mesh. Then, in step 2130, the base mesh is subdivided into a subdivided mesh, obtaining connectivity data and geometry data associated with vertices of the subdivided mesh. In step 2140, displacement data are computed. The displacement data represent spatial differences between vertices of the subdivided mesh and corresponding vertices of the mesh. Next, in step 2150, GFT coefficients are generated, based on a GFT, using the computed displacement data. These GFT coefficients and connectivity data of the base mesh are coded into the bitstream, in step 2160. As described above, this method for encoding mesh data 2100 may operate according to various operational modes that are signaled by encoding respective syntax elements into the bitstream.

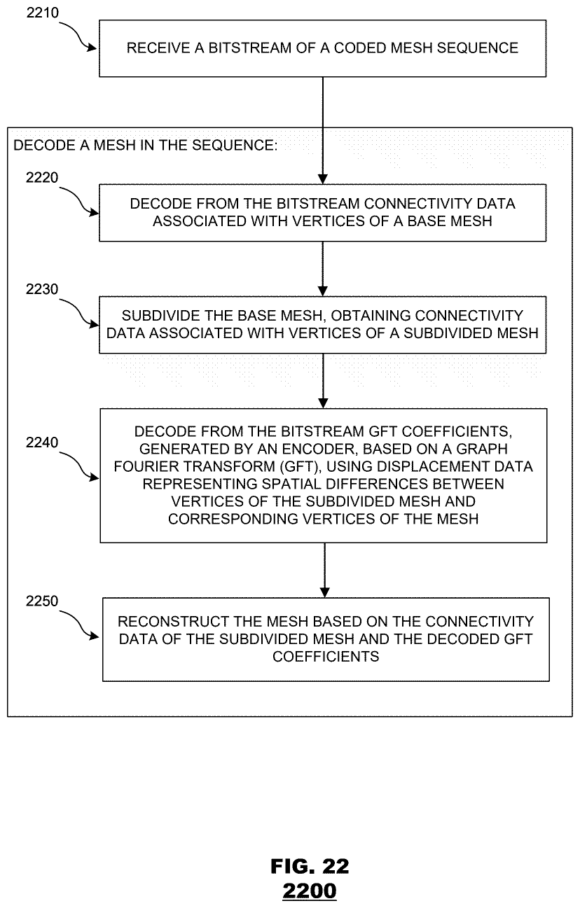

FIG. 22 is a flow diagram of an example method for decoding mesh data 2200. The method 2200 begins, in step 2210, by receiving a bitstream of a coded mesh sequence. For each of the meshes in the sequence, the method 2200 proceeds with the decoding according to steps 2220-2250. Thus, in step 2220), connectivity data associated with vertices of a base mesh are decoded from the bitstream. Then, in step 2230, the base mesh is subdivided into a subdivided mesh, obtaining connectivity data and geometry data associated with vertices of the subdivided mesh. Next, in step 2240, GFT coefficients are decoded from the bitstream. The decoded GFT coefficients were generated by an encoder, based on a GFT, using displacement data representing spatial differences between vertices of the subdivided mesh and corresponding vertices of the mesh. The mesh is reconstructed based on the connectivity data of the subdivided mesh and based on the decoded GFT coefficients. As described above, a syntax element, signaling an operational mode, can be decoded from the bitstream, and this method for decoding mesh data 2200 may further operate according to the decoded operational mode.

The illustrations of the aspects described herein are intended to provide a general understanding of the structure, function, and operation of the various aspects. The illustrations are not intended to serve as a complete description of all of the elements and features of apparatuses and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive.

The description of the aspects is provided to enable the making or use of the aspects. Various modifications to these aspects will be readily apparent, and the generic principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A method for encoding mesh data, comprising:
receiving a mesh sequence; and
coding a mesh of the sequence into a bitstream, the coding comprises:
generating a base mesh from the mesh, obtaining connectivity data and geometry data associated with vertices of the base mesh,
subdividing the base mesh, obtaining connectivity data and geometry data associated with vertices of the subdivided base mesh,
computing displacement data, representing spatial differences between vertices of the subdivided base mesh and corresponding vertices of the mesh,
generating GFT coefficients, based on a Graph Fourier Transform (GFT), using the computed displacement data, the generated GFT coefficients representative of geometry data of the mesh; and
coding into the bitstream the GFT coefficients and connectivity data of the base mesh.

2. The method according to claim 1, wherein, in a first operational mode, the generating of GFT coefficients comprises:
computing, based on the displacement data, geometry data including vertices of the mesh respective of vertices of the subdivided base mesh; and
transforming, based on the GFT, the computed geometry data into the GFT coefficients;
and further comprising:
coding into the bitstream a syntax element, signaling the first operational mode.

3. The method according to claim 1, wherein, in a second operational mode, the generating of GFT coefficients comprises:
transforming, based on the GFT, the displacement data into the GFT coefficients;
and further comprising:
coding into the bitstream the geometry data of the base mesh, and
coding into the bitstream a syntax element, signaling the second operational mode.

4. The method according to claim 1, wherein, in a third operational mode, the generating of GFT coefficients comprises:
removing, from the subdivided base mesh, vertices that correspond to vertices of the base mesh generating a reduced mesh,
computing, based on the displacement data, geometry data including vertices of the mesh respective of vertices of the reduced mesh, and
transforming, based on the GFT, the computed geometry data of the mesh-into the GFT coefficients;
and further comprising:
coding into the bitstream the geometry data of the base mesh, and
coding into the bitstream a syntax element, signaling the third operational mode.

5. The method according to claim 1, wherein, in a fourth operational mode, the generating of GFT coefficients comprises:
removing, from the subdivided base mesh, vertices that correspond to vertices of the base mesh generating a reduced mesh,
transforming, based on the GFT, part of the displacement data that is respective of vertices of the reduced mesh; into the GFT coefficients;
and further comprising:
coding into the bitstream the geometry data of the base mesh; and
coding into the bitstream a syntax element, signaling the fourth operational mode.

6. (canceled)

7. The method according to claim 1, wherein:
the coding of the mesh comprises coding mesh patches;
the subdividing of the base mesh comprises subdividing respective faces of the base mesh to generate the mesh patches, obtaining respective connectivity data sets and respective geometry data sets associated with vertices of the mesh patches;
the generating of GFT coefficients comprises generating GFT coefficient sets, based on respective GFTs, the GFT coefficient sets represent the respective mesh patches; and
the coding of GFT coefficients into the bitstream comprises coding the GFT coefficient sets.

8. The method according to claim 7, wherein the subdividing of the respective faces of the base mesh to generate the mesh patches comprises:
subdividing of the faces of the base mesh according to respective subdivision depths; and
coding into the bitstream the respective subdivision depths.

9. The method according to claim 8, further comprising:
locally adapting the subdivision depth of neighboring patches of the mesh patches so that common edges of the neighboring patches have the same number of vertices.

10. A method for decoding mesh data, comprising:
receiving a bitstream of a coded mesh sequence; and
decoding a mesh from the sequence, the decoding comprises:
decoding from the bitstream connectivity data associated with vertices of a base mesh,
subdividing the base mesh, obtaining connectivity data associated with vertices of a subdivided base mesh,
decoding from the bitstream GFT coefficients representative of geometry data of the mesh, the GFT coefficients generated by an encoder based on a GFT using displacement data representing spatial differences between vertices of the subdivided base mesh and corresponding vertices of the mesh, and
reconstructing the mesh based on the connectivity data of the subdivided base mesh and the decoded GFT coefficients.

11. The method according to claim 10, further comprising:
decoding from the bitstream a syntax element, signaling an operational mode; and
responsive to the operational mode being a first operational mode:
inverse transforming, based on the GFT, the GFT coefficients obtaining geometry data including vertices of the mesh respective of vertices of the subdivided base mesh, and
further reconstructing the mesh based on the obtained geometry data.

12. The method according to claim 10, further comprising:
decoding from the bitstream a syntax element, signaling an operational mode; and
responsive to the operational mode being a second operational mode:
decoding from the bitstream geometry data of the base mesh,
inverse transforming, based on the GFT, the GFT coefficients obtaining displacement data, and
further reconstructing the mesh based on the geometry data of the base mesh and the obtained displacement data.

13. The method according to claim 10, further comprising:
decoding from the bitstream a syntax element, signaling an operational mode; and
responsive to the operational mode being a third operational mode:
decoding from the bitstream the geometry data of the base mesh,
removing from the subdivided base mesh vertices that correspond to vertices of the base mesh generating a reduced mesh,
inverse transforming, based on the GFT, the GFT coefficients obtaining geometry data including vertices of the mesh respective of vertices of the reduced mesh, and
further reconstructing the mesh based on the obtained geometry data.

14. The method according to claim 10, further comprising:
decoding from the bitstream a syntax element, signaling an operational mode; and
responsive to the operational mode being a fourth operational mode:
decoding from the bitstream the geometry data of the base mesh,
removing from the subdivided base mesh vertices that corresponds to vertices of the base mesh generating a reduced mesh,
inverse transforming, based on the GFT, the GFT coefficients obtaining displacement data that is respective of vertices of the reduced mesh,
further reconstructing the mesh based on the geometry data of the base mesh and the obtained displacement data.

15-18. (canceled)

19. An apparatus for encoding mesh data, comprising:
at least one processor; and
memory storing instructions that, when executed by the at least one processor, cause the apparatus to:
receive a mesh sequence, and
code a mesh of the sequence into a bitstream, the coding comprises:
generating a base mesh from the mesh, obtaining connectivity data and geometry data associated with vertices of the base mesh,
subdividing the base mesh, obtaining connectivity data and geometry data associated with vertices of the subdivided base mesh,
computing displacement data, representing spatial differences between vertices of the subdivided base mesh and corresponding vertices of the mesh,
generating GFT coefficients, based on a Graph Fourier Transform (GFT), using the computed displacement data, the generated GFT coefficients representative of geometry data of the mesh; and
coding into the bitstream the GFT coefficients and connectivity data of the base mesh.

20. The apparatus according to claim 19, wherein in a first operational mode, the generating of GFT coefficients comprises:
compute, based on the displacement data, geometry data including vertices of the mesh respective of vertices of the subdivided base mesh; and
transform, based on the GFT, the computed geometry data into the GFT coefficients;
and the instructions further cause the apparatus to:
code into the bitstream a syntax element, signaling the first operational mode.

21. The apparatus according to claim 19, wherein in a second operational mode, the generating of GFT coefficients comprises:
transform, based on the GFT, the displacement data into the GFT coefficients;
and the instructions further cause the apparatus to:
code into the bitstream the geometry data of the base mesh; and
code into the bitstream a syntax element, signaling the second operational mode.

22-23. (canceled)

24. An apparatus for decoding mesh data, comprising:
at least one processor; and
memory storing instructions that, when executed by the at least one processor, cause the apparatus to:
receive a bitstream of a coded mesh sequence, and
decode a mesh from the sequence, the decoding comprises:
decoding from the bitstream connectivity data associated with vertices of a base mesh,
subdividing the base mesh, obtaining connectivity data associated with vertices of a subdivided base mesh,
decoding from the bitstream GFT coefficients representative of geometry data of the mesh, the GFT coefficients generated by an encoder based on a GFT using displacement data representing spatial differences between vertices of the subdivided base mesh and corresponding vertices of the mesh, and
reconstructing the mesh based on the connectivity data of the subdivided base mesh and the decoded GFT coefficients.

25. The apparatus according to claim 24, wherein:
the decoding of the mesh comprises decoding mesh patches,
the subdividing of the base mesh comprises subdividing respective faces of the base mesh to generate the mesh patches, obtaining respective connectivity data sets associated with vertices of the mesh patches;
the decoding from the bitstream of the GFT coefficients comprises decoding from the bitstream GFT coefficient sets, generated by the encoder based on respective GFTs, the GFT coefficient sets represent the respective mesh patches; and
the reconstructing of the mesh comprises:
reconstructing the mesh patches based on the respective connectivity data sets and the respective GFT coefficient sets, and
stitching corresponding vertices along common edges of neighboring patches of the mesh patches.

26. The apparatus according to claim 25, wherein the instructions further cause the apparatus to:
decode from the bitstream respective subdivision depths of the mesh patches, wherein the subdividing comprises subdividing of the faces of the base mesh according to the respective subdivision depths.

27. The apparatus according to claim 26, wherein the subdividing further comprising:
locally adapting the subdivision depth of neighboring patches of the mesh patches so that common edges of the neighboring patches have the same number of vertices.

28-29. (canceled)
